(19) United States
(12) Patent Application Publication
(10) Pub. No.: US 2026/0074422 A1
(43) Pub. Date: Mar. 12, 2026

(54) MULTI-FOLDABLE ELECTRONIC DEVICE INCLUDING ANTENNA

(71) Applicant: Samsung Electronics Co., Ltd., Suwon-si (KR)

(72) Inventors: Minkyung LEE, Suwon-si (KR); Kyungmoon SEOL, Suwon-si (KR); Cheolhong SON, Suwon-si (KR); Kyihyun JANG, Suwon-si (KR); Jaebong CHUN, Suwon-si (KR)

(21) Appl. No.: 19/380,463

(22) Filed: Nov. 5, 2025

Related U.S. Application Data
(63) Continuation of application No. PCT/KR2025/014010, filed on Sep. 9, 2025.

(30) Foreign Application Priority Data
Sep. 9, 2024 (KR) 10-2024-0122598
Jan. 31, 2025 (KR) 10-2025-0012613

(51) Int. Cl. H01Q 5/378; G06F 1/16; H01Q 3/02

(52) U.S. Cl. CPC H01Q 5/378; G06F 1/1618; H01Q 3/02

(57) ABSTRACT

A multi-foldable electronic device includes: a multi-foldable housing including a first housing, a second housing, a third housing between the first housing and the second housing, a first hinge rotatably connecting the first housing and the third housing, and a second hinge rotatably connecting the second housing and the third housing, wherein in a folded state of the multi-foldable electronic device; a flexible display module including a first display area disposed in the first housing, a third display area extending from the first housing and disposed in the third housing, and a second display area extending from the third display area and disposed in the second housing; at least one antenna radiator configured to transmit and/or receive signals of a designated frequency band; and a metal layer positioned in the second housing and configured to adjust frequency characteristics of the at least one antenna radiator in the folded state of the multi-foldable electronic device, wherein in the folded state of the multi-foldable electronic device, the metal layer is positioned between the first display area of the flexible display module and a ground positioned in the second housing, and is electrically connected to the ground.

### CROSS-REFERENCE TO RELATED APPLICATIONS

This application is a continuation of International Application No. PCT/KR2025/014010 designating the United States, filed on Sep. 9, 2025, in the Korean Intellectual Property Receiving Office and claiming priority to Korean Patent Application Nos. 10-2024-0122598, filed on Sep. 9, 2024, and 10-2025-0012613, filed on Jan. 31, 2025, in the Korean Intellectual Property Office, the disclosures of each of which are incorporated by reference herein in their entireties.

### BACKGROUND

### Field

The disclosure relates to a multi-foldable electronic device including an antenna.

### Description of Related Art

A multi-foldable electronic device may include metal members that overlap each other when switched from an unfolded state to a folded state.

The above information may be provided as the related art for the purpose of assisting in the understanding of the disclosure. No assertion or determination is made as to whether any of the above description may be applied as the prior art related to the disclosure.

When a multi-foldable electronic device switched from an unfolded state to a folded state, overlapping metal members may cause parasitic resonance, thereby degrading antenna radiation performance.

### SUMMARY

Embodiments of the disclosure provide a multi-foldable electronic device including an antenna that may reduce degradation of antenna radiation performance due to parasitic resonance by adjusting parasitic resonance caused by metal members that overlap each other when the multi-foldable electronic device switched from an unfolded state to a folded state.

The technical problems addressed in the disclosure are not limited to those described above, and other technical problems that are not described may be understood by those of ordinary skill in the art from the following description. Various example embodiments of the disclosure are provided to address the above-described problems.

According to example embodiments of the disclosure, a multi-foldable electronic device includes: a multi-foldable housing, a flexible display module including a flexible display, at least one antenna radiator, and a metal layer. The multi-foldable housing includes: a first housing, a second housing, and a third housing between the first housing and the second housing. The multi-foldable housing includes: a first hinge configured to rotatably connect the first housing and the third housing. The multi-foldable housing includes a second hinge configured to rotatably connect the second housing and the third housing. The multi-foldable housing is configured such that the second housing is positioned between the first housing and the third housing in a folded state of the multi-foldable electronic device. The flexible display module includes a first display area disposed in the first housing, a third display area extending from the first display area and disposed in the third housing, and a second display area extending from the third display area and disposed in the second housing. At least one antenna radiator is configured to transmit and/or receive a signal of a designated frequency band. The metal layer is positioned in the second housing and is configured to adjust a frequency characteristic for at least one antenna radiator in a folded state of the multi-foldable electronic device. The metal layer is positioned between the first display area of the flexible display module and a ground structure positioned in the second housing in the folded state of the multi-foldable electronic device. The metal layer is electrically connected to the ground structure.

A multi-foldable electronic device including an antenna according to various example embodiments of the disclosure can reduce degradation in antenna radiation performance (e.g., radio wave transmission and reception performance) caused by parasitic resonance, by preventing/suppressing the parasitic resonance arising from overlapping metal members during transition from an unfolded state to a folded state from falling within an operating frequency band of at least one antenna radiator.

Further, the effects that may be obtained from various embodiments of the disclosure are directly or implicitly disclosed in the detailed description of the example embodiments of the disclosure.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example electronic device within a network environment according to various embodiments;

FIG. 2A is a diagram illustrating an example unfolded multi-foldable electronic device according to various embodiments;

FIG. 2B is a diagram illustrating an example unfolded multi-foldable electronic device according to various embodiments;

FIG. 2C is a diagram illustrating a portion of an unfolded multi-foldable electronic device according to various embodiments;

FIG. 3A is a diagram illustrating a multi-foldable electronic device in a folded state according to various embodiments;

FIG. 3B is a diagram illustrating a multi-foldable electronic device in a folded state according to various embodiments;

FIG. 3C is a diagram illustrating a side view of a multi-foldable electronic device in a folded state according to various embodiments;

FIG. 4A is a partial cross-sectional perspective view illustrating a portion of a multi-foldable electronic device in a folded state taken along line EE′ of FIG. 3A according to various embodiments;

FIG. 4B is a partial cross-sectional perspective view illustrating a portion of a multi-foldable electronic device in a folded state taken along line EE′ of FIG. 3A according to various embodiments;

FIG. 5 is a cross-sectional view illustrating a portion of a multi-foldable electronic device in a folded state taken along line FF′ of FIG. 3A according to various embodiments;

FIG. 6 is a partial exploded perspective view illustrating a multi-foldable electronic device in an unfolded state according to various embodiments;

FIG. 7 is a diagram illustrating an unfolded multi-foldable electronic device according to various embodiments;

FIG. 8A is a cross-sectional view illustrating a portion of a multi-foldable electronic device in a folded state taken along line EE′ of FIG. 3A according to various embodiments;

FIG. 8B is a cross-sectional view illustrating a portion of a multi-foldable electronic device in a folded state taken along line EE′ of FIG. 3A according to various embodiments;

FIG. 9 is a cross-sectional view illustrating a portion of a foldable electronic device of a comparative example for comparison with FIG. 8B according to various embodiments;

FIG. 10 is a graph illustrating antenna radiation performance in a folded state of a multi-foldable electronic device of the disclosure and a multi-foldable electronic device of a comparative example according to various embodiments;

FIG. 11 is a partial exploded perspective view illustrating a multi-foldable electronic device in an unfolded state according to various embodiments;

FIG. 12A is a diagram illustrating a shape of a metal layer in a multi-foldable electronic device according to various embodiments of the disclosure, and illustrating heat maps of an electric field distribution and a frequency of parasitic resonance according to the shape of the metal layer according to various embodiments;

FIG. 12B is a graph illustrating radiation efficiency in a folded state of a multi-foldable electronic device according to a shape of a metal layer according to various embodiments;

FIG. 12C is a graph illustrating total efficiency in a folded state of a multi-foldable electronic device according to a shape of a metal layer according to various embodiments;

FIG. 13 is a diagram illustrating a shorting point on a metal layer in a multi-foldable electronic device according to various embodiments of the disclosure and a graph illustrating radiation efficiency in a folded state of the multi-foldable electronic device according to the shorting point according to various embodiments;

FIG. 14 is a graph illustrating antenna radiation performance for a first antenna including at least one first antenna radiator in a multi-foldable electronic device in a folded state according to element values of a first matching circuit according to various embodiments;

FIG. 15 is a graph illustrating antenna radiation performance for a second antenna including at least one second antenna radiator in a multi-foldable electronic device in a folded state according to element values of a second matching circuit according to various embodiments;

FIG. 16 is a graph illustrating antenna radiation performance for a first antenna including at least one first antenna radiator in a multi-foldable electronic device in a folded state according to various embodiments;

FIG. 17 is a graph illustrating antenna radiation performance for a second antenna including at least one second antenna radiator in a multi-foldable electronic device in a folded state according to various embodiments;

FIG. 18 is a diagram illustrating a portion of a multi-foldable electronic device in an unfolded state according to various embodiments;

FIG. 19 is a diagram illustrating a folded state of a multi-foldable electronic device according to various embodiments;

FIG. 20 is a diagram illustrating a folded state of a multi-foldable electronic device according to various embodiments; and

FIG. 21 is a diagram illustrating a slidable electronic device according to various embodiments.

### DETAILED DESCRIPTION

Hereinafter, various example embodiments of the disclosure will be described in greater detail. The following description is provided to facilitate a comprehensive understanding of various embodiments of the disclosure defined by the claims and their equivalents with reference to the accompanying drawings. Although various specific details are provided herein to aid understanding, they are to be regarded as illustrative only. Accordingly, those skilled in the art will recognize that various changes and modifications may be made to various embodiments described in the disclosure without departing from the scope and spirit of the disclosure. Further, descriptions of well-known functions and configurations may be omitted for clarity and conciseness.

The terms and words used in the following description and claims are not limited to their literal meanings, but are merely used to aid in understanding the disclosure clearly and consistently. Accordingly, it should be apparent to those skilled in the art that the following description of various embodiments of the disclosure is provided for the purpose of description, and is not intended to limit the disclosure as defined by the appended claims and their equivalents.

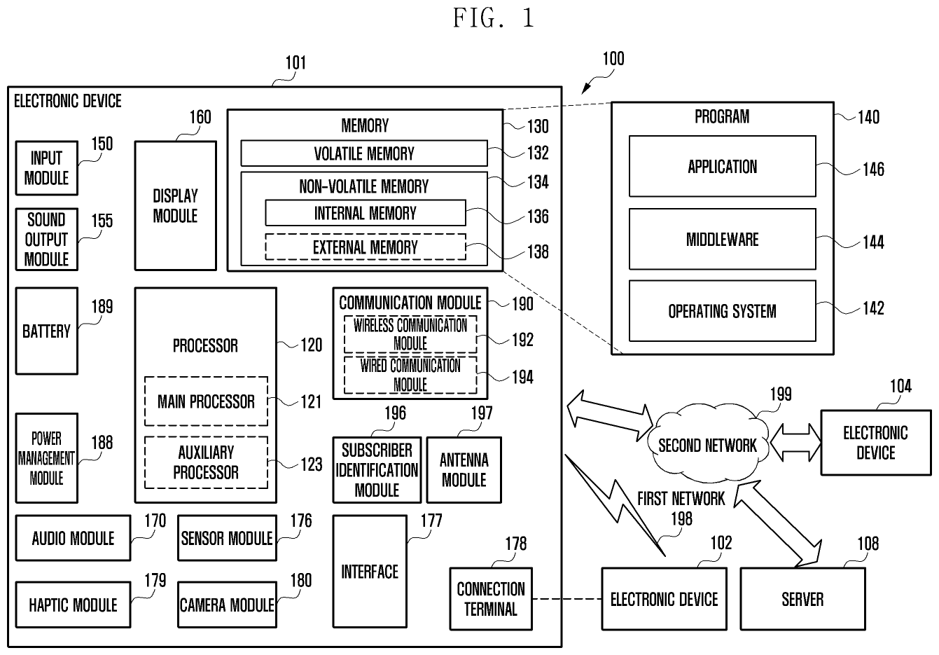

FIG. 1 is a block diagram illustrating an example electronic device 101 in a network environment 100 according to various embodiments of the disclosure.

Referring to FIG. 1, the electronic device 101 in the network environment 100 may communicate with an external electronic device 102 via a first network 198 (e.g., a short-range wireless communication network), or at least one of an external electronic device 104 or a server 108 via a second network 199 (e.g., a long-range wireless communication network). The electronic device 101 may communicate with the external electronic device 104 via the server 108. The electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, and/or an antenna module 197. In various embodiments of the disclosure, at least one (e.g., the connection terminal 178) of the components may be omitted from the electronic device 101, or one or more other components may be added in the electronic device 101. In various embodiments of the disclosure, some of the components may be implemented as single integrated circuitry. For example, the sensor module 176, the camera module 180, or the antenna module 197 may be implemented as embedded in single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor 120 may execute, for example, software (e.g., a program 140) to control at least one other component (e.g., a hardware or software component) of the electronic device 101 coupled with the processor 120, and may perform various data processing or computation. As at least part of the data processing or computation, the processor 120 may load a command or data accommodated from another component (e.g., the sensor module 176 or the communication module 190) in a volatile memory 132, process the command or the data stored in the volatile memory 132, and store resulting data in a non-volatile memory 134. The processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). The auxiliary processor 123 (e.g., an ISP or a CP) may be implemented as part of another component (e.g., the camera module 180 or the communication module 190) functionally related to the auxiliary processor 123. According to various embodiments of the disclosure, the auxiliary processor 123 (e.g., a neural network processing device) may include a hardware structure specified for processing an artificial intelligence model. The artificial intelligence model may be created through machine learning. Such learning may be performed, for example, in the electronic device 101 itself on which the artificial intelligence model is performed, or may be performed through a separate server (e.g., the server 108). The learning algorithms may include, for example, supervised learning, unsupervised learning, semi-supervised learning, or reinforcement learning, but is not limited thereto. The artificial intelligence model may include a plurality of artificial neural network layers. The artificial neural network may be any of a deep neural network (DNN), a convolutional neural network (CNN), a recurrent neural network (RNN), a restricted Boltzmann machine (RBM), a deep belief network (DBN), a bidirectional recurrent DNN (BRDNN), a deep Q-network, or a combination of two or more of the above-mentioned networks, but is not limited the above-mentioned examples. In addition to the hardware structure, the artificial intelligence model may additionally or alternatively include a software structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 and/or the non-volatile memory 134.

The program 140 may be stored in the memory 130 as software, and may include, for example, an operating system (OS) 142, middleware 144, and/or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record, and the receiver may be used for incoming calls. The receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. The display module 160 may include touch circuitry (e.g., a touch sensor) adapted to detect a touch, or sensor circuitry (e.g., a pressure sensor) adapted to measure the intensity of force incurred by the touch.

The audio module 170 may convert a sound into an electrical signal and vice versa. The audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. The sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. The interface 177 may include, for example, a high-definition multimedia interface (HDMI), a universal serial bus (USB) interface, a secure digital (SD) card interface, and/or an audio interface.

The connecting terminal 178 may include a connector via which the electronic device 101 may be physically connected with the external electronic device (e.g., the external electronic device 102). The connecting terminal 178 may include, for example, an HDMI connector, a USB connector, an SD card connector, and/or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. The haptic module 179 may include, for example, a motor, a piezoelectric element, or an electric stimulator.

The camera module 180 may capture a still image or moving images. The camera module 180 may include one or more lenses, image sensors, ISPs, or flashes.

The power management module 188 may manage power supplied to or consumed by the electronic device 101. The power management module 188 may be implemented as at least part of, for example, a power management integrated circuit (PMIC).

The battery 189 may supply power to at least one component of the electronic device 101. The battery 189 may include, for example, a primary cell which is not rechargeable, a secondary cell which is rechargeable, and/or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more CPs that are operable independently from the processor 120 (e.g., the AP) and supports a direct (e.g., wired) communication or a wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BLUETOOTH, wireless-fidelity (Wi-Fi) direct, or IR data association (IrDA)) or the second network 199 (e.g., a long-range communication network, such as a legacy cellular network, a 5th generation (5G) network, a next generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4th generation (4G) network, and next-generation communication technology, e.g., new radio (NR) access technology. The NR access technology may support high-speed transmission of high-capacity data (e,g., enhanced mobile broadband (eMBB)), minimization of terminal power and connection of multiple terminals (massive machine type communications (mMTC)), or high reliability and low latency (ultra-reliable and low-latency communications (URLLC)). The wireless communication module 192 may support a high-frequency band (e.g., a mmWave band) to achieve, for example, a high data transmission rate. The wireless communication module 192 may support various technologies for securing performance in a high-frequency band, such as beamforming, massive multiple-input and multiple-output (MIMO), full-dimensional MIMO (FD-MIMO), array antenna, analog beam-forming, or large-scale antenna. The wireless communication module 192 may support various requirements specified in the electronic device 101, an external electronic device (e.g., external the electronic device 104), or a network system (e.g., the second network 199). According to various embodiments of the disclosure, the wireless communication module 192 may support a peak data rate for implementing eMBB (e.g., 20 Gbps or more), loss coverage for implementing mMTC (e.g., 164 dB or less), or U-plane latency for realizing URLLC (e.g., 0.5 ms or less for each of downlink (DL) and uplink (UL) or 1 ms or less for round trip).

The antenna module 197 may transmit or receive a signal or power to or from the outside (e.g., the external electronic device) of the electronic device 101. The antenna module 197 may include an antenna including a radiating element including a conductive material or a conductive pattern formed in or on a substrate (e.g., a printed circuit board (PCB)). The antenna module 197 may include a plurality of antennas (e.g., an antenna array). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or accommodated between the communication module 190 and the external electronic device via the selected at least one antenna. Another component (e.g., a radio frequency integrated circuit (RFIC)) other than the radiating element may be additionally formed as part of the antenna module 197.

According to various embodiments of the disclosure, the antenna module 197 may form a mm Wave antenna module. According to various embodiments of the disclosure, the mm Wave antenna module may include a PCB, an RFIC that is disposed on or adjacent to a first surface (e.g., the bottom surface) of the PCB and is capable of supporting a predetermined high-frequency band (e.g., a mmWave band), and a plurality of antennas (e.g., array antennas) that is disposed on or adjacent to a second surface (e.g., the top surface or the side surface) of the PCB and is capable of transmitting or receiving a signal of the predetermined high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or accommodated between the electronic device 101 and the external electronic device 104 via the server 108 coupled with the second network 199. Each of the external electronic devices 102 or 104 may be a device of a same type as, or a different type, from the electronic device 101. All or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide an ultra-low delay service using, for example, distributed computing or MEC. In various embodiments of the disclosure, the external electronic device 104 may include an internet of things (IoT) device. The server 108 may be an intelligent server using machine learning and/or neural networks. According to various embodiments of the disclosure, the external electronic device 104 or the server 108 may be included in the second network 199. The electronic device 101 may be applied to an intelligent service (e.g., smart home, smart city, smart car, or healthcare) based on 5G communication technology or IoT-related technology.

Various embodiments of the disclosure and the terms used herein are not intended to limit the technological features set forth herein to particular embodiments and include various changes, equivalents, or replacements for a corresponding embodiment. With regard to the description of the drawings, similar reference numerals may be used to refer to similar or related elements.

It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). If an element (e.g., a first element) is referred to, with or without the term “operatively” or “communicatively,” as “coupled with,” “coupled to,” “connected with,” or “connected to” another element (e.g., a second element), the element may be coupled with the other element directly (e.g., wiredly), wirelessly, or via a third element.

The term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to various embodiments of the disclosure, the module may be implemented in a form of an application-specific integrated circuit (ASIC).

Various embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

A method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PLAYSTORE™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

Each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. In such a case, the integrated component may perform one or more functions of each of the plurality of components in the same or similar manner as they are performed by a corresponding one of the plurality of components before the integration. Operations performed by the module, the program, or another component may be carried out sequentially, in parallel, repeatedly, or heuristically, or one or more of the operations may be executed in a different order or omitted, or one or more other operations may be added.

In the disclosure, the term ‘disposed on XX’ may be understood to include being disposed adjacent to XX, disposed in substantially contact with XX, or coupled to XX.

In the disclosure, the term ‘positioned on XX’ may be understood to include being positioned adjacent to XX, in substantially contact with XX, coupled to XX, or included in XX.

In the disclosure, in the case that a first component (or area, layer, portion, and the like) is described as being ‘on,’ ‘connected to,’ or ‘coupled to’ a second component, it may be understood that the first component may be directly disposed on, connected, or coupled to the second component, or that a third component may be disposed therebetween.

In the disclosure, ‘ZZ between XX and YY’ may be understood as ZZ being disposed in substantial contact with XX or YY, or ZZ being directly coupled to XX or YY. ‘ZZ between XX and YY’ may be understood as ZZ being positioned between XX and YY with at least one other component between XX and ZZ, and/or at least one component between YY and ZZ interposed therebetween. ‘ZZ between XX and YY’ may be understood as at least one other component between XX and ZZ connecting XX and ZZ, and/or at least one other component between YY and ZZ connecting YY and ZZ.

In the disclosure, unless otherwise stated, ‘conductivity’ may be understood as ‘electrical conductivity’ and ‘non-conductivity’ may be understood as ‘electrical insulation.’ In context, or in the case that a property related to heat is described, ‘conductivity’ may be interpreted as ‘thermal conductivity.’

In the disclosure, in the case that the term ‘substantially’ is used for defining a structural part, an expression including the term ‘substantially’ is understood or interpreted as referring to a technical feature produced within the technical tolerance of the manufacturing method.

In the disclosure, the term “and/or” may be understood to include all possible combinations of one or more of the associated components.

In the disclosure, the expression ‘comprising’ may refer, for example, to a particular effect or result being achieved within a particular tolerance, and that a person skilled in the art understands how to achieve such tolerance. It should be understood that terms such as ‘comprising’ or ‘having’ indicate the presence of a feature, number, step, operation, component, part, or combination thereof described in the disclosure, but do not preclude the presence or addition of one or more other features, numbers, steps, operations, components, parts, or combinations thereof.

In the drawings of the disclosure, the shape, thickness, ratio, and/or size of the components are/is only for the effective description of the technical contents and are/is not limited to the illustrated shape, thickness, ratio, and/or size.

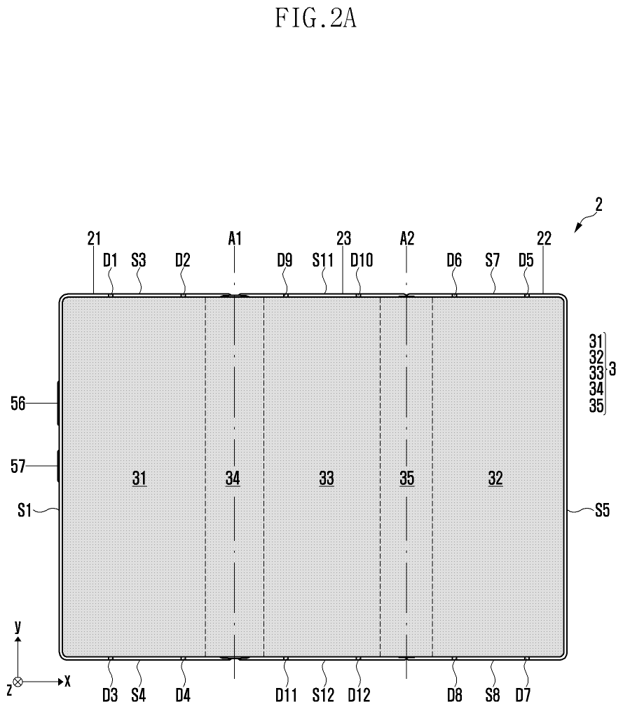

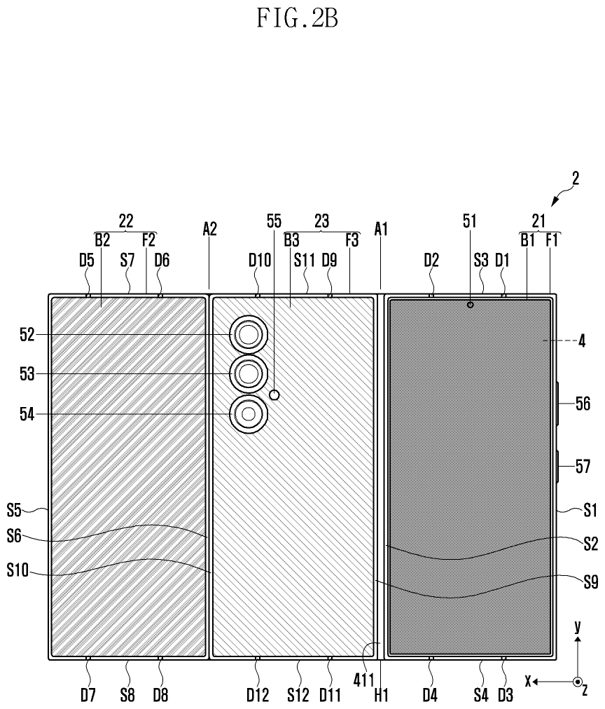

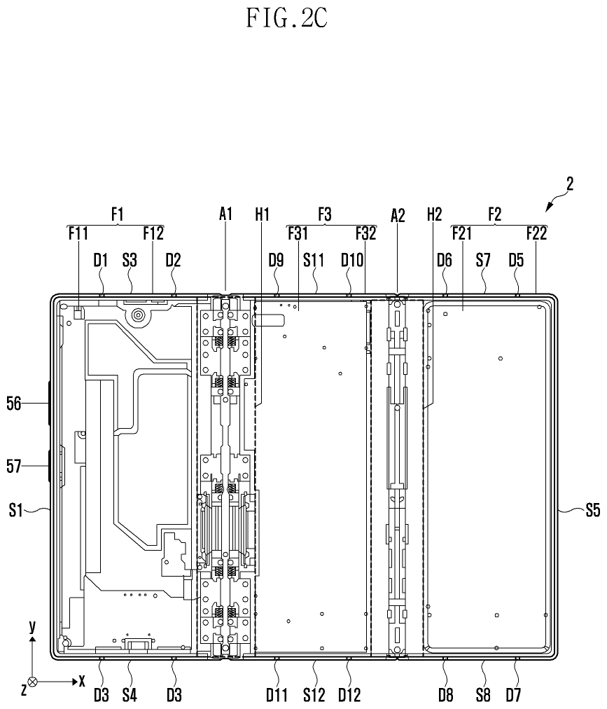

FIG. 2A is a diagram illustrating an example multi-foldable electronic device 2 in an unfolded state (also referred to as an unfolding state or a flat state) according to various embodiments.

FIG. 2B is a diagram illustrating an unfolded multi-foldable electronic device 2 according to various embodiments;

FIG. 2C is a diagram illustrating a portion of an unfolded multi-foldable electronic device 2 according to various embodiments;

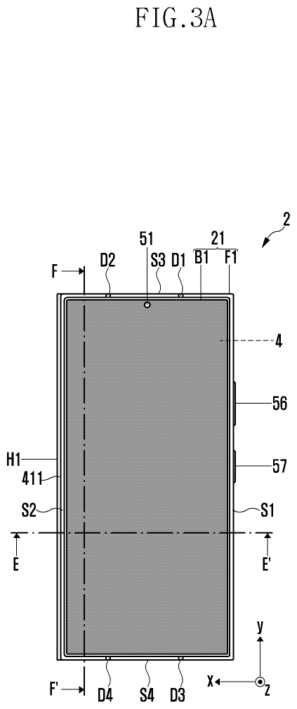

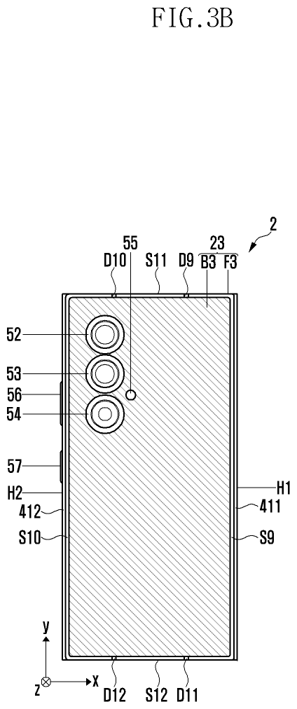

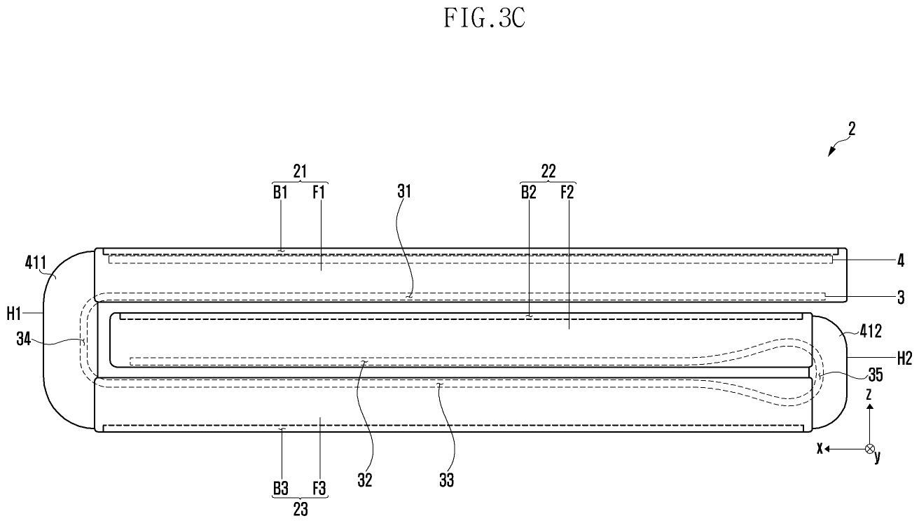

FIG. 3A is a diagram illustrating a multi-foldable electronic device 2 in a folded state (also referred to as a folding state) according to various embodiments;

FIG. 3B is a diagram illustrating a multi-foldable electronic device 2 in a folded state according to various embodiments;

FIG. 3C is a diagram illustrating a multi-foldable electronic device 2 in a folded state according to various embodiments;

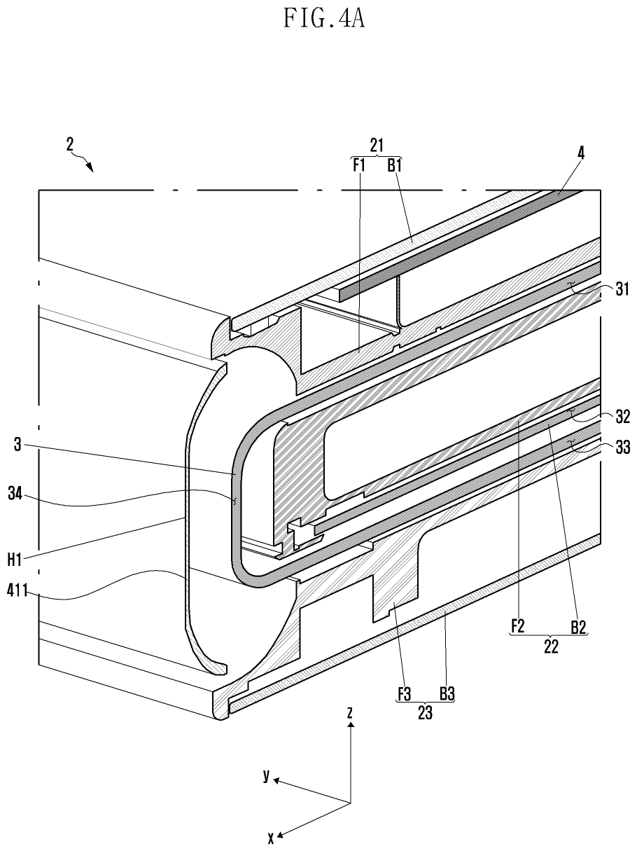

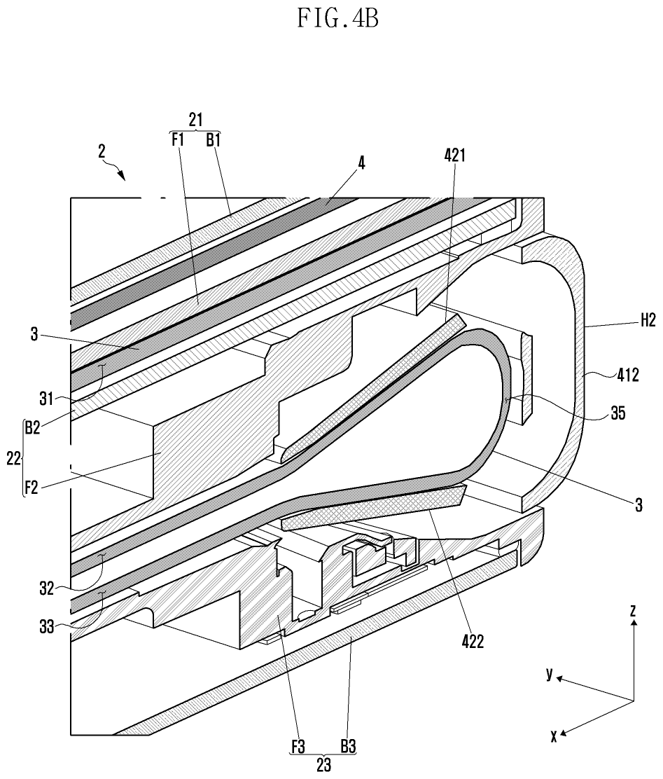

FIG. 4A is a partial cross-sectional perspective view illustrating a portion of a multi-foldable electronic device 2 in a folded state taken along line EE′ of FIG. 3A according to various embodiments;

FIG. 4B is a partial cross-sectional perspective view illustrating a portion of a multi-foldable electronic device 2 in a folded state taken along line EE′ of FIG. 3A according to various embodiments;

It should be understood that various combinations of features and/or embodiments disclosed in connection with FIGS. 2A, 2B, 2C, 3A, 3B, 3C, 4A, and 4B are contemplated and encompassed by the disclosure. Various combinations of features described below in connection with FIGS. 2A, 2B, 2C, 3A, 3B, 3C, 4A, and 4B may be considered to be included in the disclosure as specific examples.

With reference to FIGS. 2A, 2B, 2C, 3A, 3B, 3C, 4A, and 4B, a multi-foldable electronic device 2 (e.g., the electronic device 101 of FIG. 1) may include a first housing 21, a second housing 22, and a third housing 23 between the first housing 21 and the second housing 22. The multi-foldable electronic device 2 may be implemented to be foldable between the first housing 21 and the third housing 23. The multi-foldable electronic device 2 may include a first hinge part (also referred to as a first hinge module, a first hinge structure, a first hinge or a first hinge assembly) H1 configured to rotatably connect the first housing 21 and the third housing 23. The multi-foldable electronic device 2 may be implemented to be foldable between the second housing 22 and the third housing 23. The multi-foldable electronic device 2 may include a second hinge part (also referred to as a second hinge module, a second hinge structure, second hinge or a second hinge assembly) H2 configured to rotatably connect the second housing 22 and the third housing 23. The combination of the first housing 21, the second housing 22, the third housing 23, the first hinge part H1, and the second hinge part H2 may be understood as a multi-foldable housing of the multi-foldable electronic device 2.

According to various embodiments, in a folded state of the multi-foldable electronic device 2, the second housing 22 may be positioned between the first housing 21 and the third housing 23. In an unfolded state of the multi-foldable electronic device 2, the first housing 21 and the third housing 23 may form an angle of substantially about 180 degrees, and the second housing 22 and the third housing 23 may form an angle of substantially about 180 degrees. In the folded state of the multi-foldable electronic device 2, the first housing 21 and the third housing 23 may form an angle of about 0 degrees to about 10 degrees. In the folded state of the multi-foldable electronic device 2, the second housing 22 and the third housing 23 may form an angle of about 0 degrees to about 10 degrees.

According to various embodiments, the multi-foldable electronic device 2 may include a first display module 3 (e.g., the display module 160 of FIG. 1). The first display module 3 may be disposed in or coupled to the first housing 21, the second housing 22, and the third housing 23. The first display module 3 may be a flexible display module or a foldable display module configured to be bendable for transition between the unfolded state and the folded state of the multi-foldable electronic device 2. In the unfolded state of the multi-foldable electronic device 2, the first display module 3 may be provided substantially flat. In the folded state of the multi-foldable electronic device 2, the first display module 3 may not be visible to the outside.

According to various embodiments, the first display module 3 may include a first display area 31 disposed in or coupled to the first housing 21, a second display area 32 disposed in or coupled to the second housing 22, and a third display area 33 disposed in or coupled to the third housing 23. The first display area 31 may be supported by the first housing 21 and disposed substantially flat in the first housing 21. The second display area 32 may be supported by the second housing 22 and disposed substantially flat in the second housing 22. The third display area 33 may be supported by the third housing 23 and disposed substantially flat in the third housing 23. In the folded state of the multi-foldable electronic device 2, the second display area 32 disposed in the second housing 22 and the third display area 33 disposed in the third housing 23 may face each other between the second housing 22 and the third housing 23. In the folded state of the multi-foldable electronic device 2, the first display area 31 disposed in the first housing 21 may face the second housing 22.

According to various embodiments, the first display module 3 may include a first bendable display area 34 between the first display area 31 and the third display area 33. The first bendable display area 34 may be disposed at the first hinge part H1. When the multi-foldable electronic device 2 switching between an unfolded state and a folded state, the first bendable display area 34 may be deformed in response to a relative position between the first display area 31 and the third display area 33. In the unfolded state of the multi-foldable electronic device 2, the first bendable display area 34 may be disposed substantially flat. In the folded state of the multi-foldable electronic device 2, the first bendable display area 34 may be disposed in a bent form. In various embodiments, the first hinge part H1 may be configured to support the first bendable display area 34. For example, in the unfolded state of the multi-foldable electronic device 2, the first hinge part H1 may be configured to support substantially flat the first bendable display area 34. The first hinge part H1 may, for example, reduce a crease phenomenon in the first bendable display area 34 by supporting the first bendable display area 34 so that the first bendable display area 34 may be disposed flat without sagging or with reduced sagging, in the unfolded state of the multi-foldable electronic device 2.

According to various embodiments, the first display module 3 may include a second bendable display area 35 between the second display area 32 and the third display area 33. The second bendable display area 35 may be disposed in the second hinge part H2. When the multi-foldable electronic device 2 switching between an unfolded state and a folded state, the second bendable display area 35 may be deformed in response to the relative position between the second display area 32 and the third display area 33. In the unfolded state of the multi-foldable electronic device 2, the second bendable display area 35 may be disposed substantially flat. In the folded state of the multi-foldable electronic device 2, the second bendable display area 35 may be disposed in a bent form. In various embodiments, the second hinge part H2 may be configured to support the second bendable display area 35. For example, in the unfolded state of the multi-foldable electronic device 2, the second hinge part H2 may be configured to support substantially flat the second bendable display area 35. The second hinge part H2 may, for example, reduce a creasing phenomenon in the second bendable display area 35 by supporting the second bendable display area 35 so that the second bendable display area 35 may be disposed flat without sagging or with reduced sagging in the unfolded state of the multi-foldable electronic device 2.

According to various embodiments, in the folded state of the multi-foldable electronic device 2, the first bendable display area 34 of the first display module 3 may be bent in a symmetrical shape with respect to a first center line A1. When viewing the unfolded state of the multi-foldable electronic device 2, the first center line A1 may correspond to the center of the width of the first bendable display area 34, which extends from a first boundary between the first display area 31 and the first bendable display area 34 to a second boundary between the third display area 33 and the first bendable display area 34. In various embodiments, the first center line A1 of the multi-foldable electronic device 2 may be understood as a first folding axis of the multi-foldable housing or the multi-foldable electronic device 2. The first center line A1 may be substantially provided (or formed) by the first hinge part H1.

According to various embodiments, in the folded state of the multi-foldable electronic device 2, the second bendable display area 35 of the first display module 3 may be bent in a symmetrical shape with respect to a second center line A2. When viewing the unfolded state of the multi-foldable electronic device 2, the second center line A2 may correspond to the center of the width of the second bendable display area 35, which extends from a third boundary between the second display area 32 and the second bendable display area 35 to a fourth boundary between the third display area 33 and the second bendable display area 35. In various embodiments, the second center line A2 of the multi-foldable electronic device 2 may be understood as a second folding axis of the multi-foldable housing or the multi-foldable electronic device 2. The second center line A2 may be substantially provided (or formed) by the second hinge part H2. The first center line A1 and the second center line A2 may be substantially parallel to each other.

The illustrated coordinate axes are based on the first housing 21. The first display area 31 of the first display module 3 may provide (or form) at least a portion of a first front area of the multi-foldable electronic device 2, and the first front area may face in the negative direction of the Z-axis. The first front area may be substantially parallel to the XY plane, and the Y-axis may be parallel to the first center line A1.

According to various embodiments, the first housing 21 may include a first frame (also referred to as a first frame structure or a first framework) F1, and a first back cover (also referred to as a first rear cover, a first rear plate, or a first back plate) B1 disposed in (or coupled to) the first frame F1. The first frame F1 may provide (or form) at least a portion of a first side area of the exterior of the multi-foldable electronic device 2. The first back cover B1 may provide (or form) at least a portion of a first rear area of the exterior of the multi-foldable electronic device 2. The first display area 31 of the first display module 3 may provide (or form) at least a portion of the first front area of the multi-foldable electronic device 2, and the first back cover B1 may provide (or form) a first rear area of the first housing 21 facing in the direction opposite to the first front area. When viewed from above the first display area 31 of the first display module 3 or when viewed from above the first front area of the multi-foldable electronic device 2, it may be understood as when viewed in the positive Z-axis direction. The direction orthogonal to the first display area 31 of the first display module 3 or the direction orthogonal to the first front area of the multi-foldable electronic device 2 may be understood as a direction parallel to the Z-axis. When viewed from above the first back cover B1 or when viewed from above the first rear area of the first housing 21, it may be understood as when viewed in the negative Z-axis direction. The direction perpendicular to the first back cover B1 or the direction perpendicular to the first rear area of the first housing 21 may be understood as a direction parallel to the Z-axis.

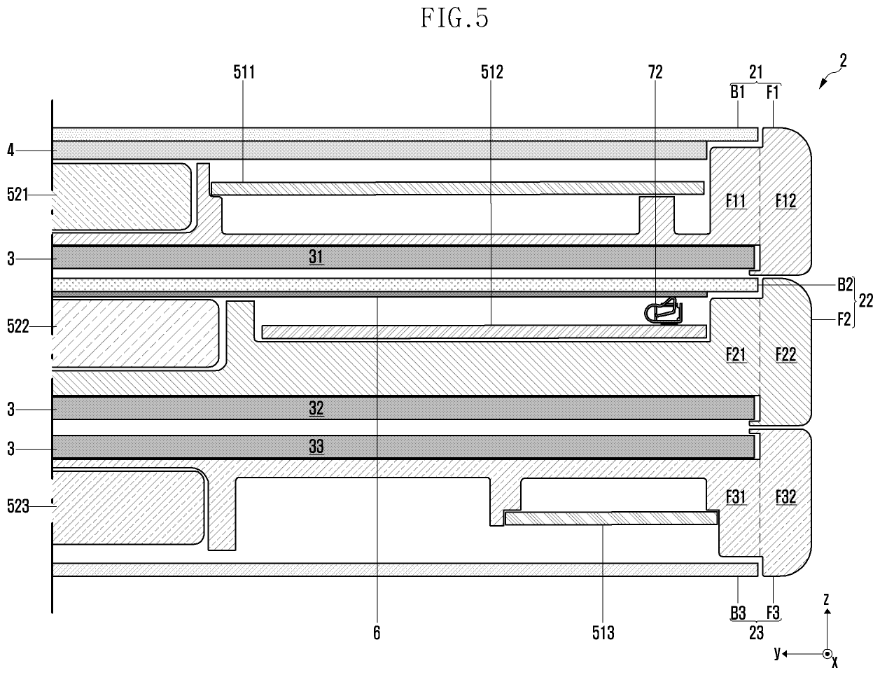

According to various embodiments, a first frame F1 of the first housing 21 may include a first side member (also referred to as a first lateral member, a first side structure, or a first side bezel structure) F12. The first side member F12 may provide (or form) at least a portion of a first side area of the exterior of the foldable electronic device 2. The first frame F1 may include a first bracket (also referred to as a first support plate, a first support member, a first support structure, or a first support portion) F11 extended from the first side member F12 or connected to the first side member F12. The first frame F1 may be provided (or formed) as an integrated or single structure (e.g., a single continuous structure or a complete structure) including the first side member F12 and the first bracket F11. The first frame F1 may be provided (or formed) as a combination of a conductor (or metal body) (not separately illustrated) including one or more conductive portions (also referred to as metal portions) and a non-conductor (or non-metal body) (not separately illustrated) including one or more non-conductive portions (also referred to as non-metal portions). In the disclosure, a ‘conductor’ may be understood as an electrical conductor, and a ‘non-conductor’ may be understood as an electrical insulator. The first bracket F11 may be a structural element positioned inside the multi-foldable electronic device 2 corresponding to the first housing 21. The first bracket F11 may be positioned at least partially between the first display area 31 of the first display module 3 and the first back cover B1 of the first housing 21. Various members related to the first display area 31 of the first display module 3, at least one first printed circuit board (PCB) (e.g., at least one first PCB 511 of FIG. 5), and/or electrical elements such as a first battery (e.g., the first battery 521 of FIG. 5), and/or electrical components may be at least partially disposed in or coupled to the first frame F1 (e.g., the first bracket F11) between the first frame F1 and the first back cover B1.

According to various embodiments, the first side member F12 of the first frame F1 may include a first side (also referred to as a first side portion) S1, a second side (also referred to as a second side portion) S2, a third side (also referred to as a third side portion) S3, and a fourth side (also referred to as a fourth side portion) S4. The first side S1 and the second side S2 may have a length extending in a direction parallel to the first center line A1. The second side S2 may be positioned closer to the first center line A than the first side S1. The third side S3 may extend from one end of the first side S1 and one end of the second side S2, or may connect one end of the first side S1 and one end of the second side S2. The fourth side S4 may extend from the other end of the first side S1 and the other end of the second side S2, or may connect the other end of the first side S1 and the other end of the second side S2. The third side S3 and the fourth side S4 may have a length extending in a direction perpendicular to the first center line A1. The third side S3 and the fourth side S4 may be perpendicular to the first side S1 and the second side S2. A corner between the first side S1 and the third side S3, a corner between the first side S1 and the fourth side S4, a corner between the second side S2 and the third side S3, and/or a corner between the second side S2 and the fourth side S4 may be provided (or formed) as a smooth curve. When viewed from above the first back cover B1, the first side S1, the second side S2, the third side S3, and the fourth side S4 may surround the first back cover B1.

According to various embodiments, an integrated or single structure (e.g., a single continuous structure or a complete structure) replacing the first back cover B1 and the first frame F1 may be provided (or formed).

According to various embodiments, the second housing 22 may include a second frame (also referred to as a second frame structure or a second framework) F2, and a second back cover (also referred to as a second rear cover, a second rear plate, or a second back plate) B2 disposed in (or coupled) to the second frame F2. The second frame F2 may provide (or form) at least a portion of a second side area of the exterior of the multi-foldable electronic device 2. The second back cover B2 may provide (or form) at least a portion of a second rear area of the exterior of the multi-foldable electronic device 2. The second display area 32 of the first display module 3 may provide (or form) at least a portion of a second front area of the multi-foldable electronic device 2, and the second back cover B2 may provide (or form) a second rear area of the second housing 22 facing in a direction opposite to the second front area. When viewed from above the second display area 32 of the first display module 3 or when viewed from above the second front area of the multi-foldable electronic device 2, it may be understood as when viewed in a direction orthogonal to the second display area 32 of the first display module 3 or when viewed in a direction orthogonal to the second front area of the multi-foldable electronic device 2. When viewed from above the second back cover B2 or when viewed from above the second rear area of the second housing 22, it may be understood as when viewed in a direction orthogonal to the second back cover B2 or when viewed in the direction orthogonal to the second rear area of the second housing 22.

According to various embodiments, the second frame F2 of the second housing 22 may include a second side member (also referred to as a second lateral member, a second side structure, or a second side bezel structure) F22. The second side member F22 may provide (or form) at least a portion of a second side area of the exterior of the foldable electronic device 2. The second frame F2 may include a second bracket (also referred to as a second support plate, a second support member, a second support structure, or a second support portion) F21 extended from or connected to the second side member F22. The second frame F2 may be provided (or formed) as an integrated or single structure (e.g., a single continuous structure or a complete structure) including the second side member F22 and the second bracket F21. The second frame F2 may be provided (or formed) by a combination of a conductor (or metal body) (not separately illustrated) including one or more conductive portions (also referred to as metal portions) and a non-conductor (or non-metal body) (not separately illustrated) including one or more non-conductive portions (also referred to as non-metal portions). The second bracket F21 may be a structural element positioned inside the multi-foldable electronic device 2 corresponding to the second housing 22. The second bracket F21 may be positioned at least partially between the second display area 32 of the first display module 3 and the second back cover B2 of the second housing 22. Various members related to electrical elements such as the second display area 32 of the first display module 3, at least one second PCB (e.g., at least one second PCB 512 of FIG. 5), and/or the second battery (e.g., a second battery 522 of FIG. 5), and/or electrical components, may be at least partially disposed in or coupled to the second frame F2 (e.g., the second bracket F21) between the second frame F2 and the second back cover B2.

According to various embodiments, the second side member F22 of the second frame F2 may include a fifth side (also referred to as a fifth side portion) S5, a sixth side (also referred to as a sixth side portion) S6, a seventh side (also referred to as a seventh side portion) S7, and an eighth side (also referred to as an eighth side portion) S8. The fifth side S5 and the sixth side S6 may have a length extending in a direction parallel to the second center line A2. The sixth side S6 may be positioned closer to the second center line A2 than the fifth side S5. The seventh side S7 may extend from one end of the fifth side S5 and one end of the sixth side S6, or may connect one end of the fifth side S5 and one end of the sixth side S6. The eighth side S8 may extend from the other end of the fifth side S5 and the other end of the sixth side S6, or may connect the other end of the fifth side S5 and the other end of the sixth side S6. The seventh side S7 and the eighth side S8 may have a length extending in a direction perpendicular to the second center line A2. The seventh side S7 and the eighth side S8 may be perpendicular to the fifth side S5 and the sixth side S6. A corner between the fifth side S5 and the seventh side S7, a corner between the fifth side S5 and the eighth side S8, a corner between the sixth side S6 and the seventh side S7, and/or a corner between the sixth side S6 and the eighth side S8 may be provided (or formed) as a smooth curve. When viewed from above the second back cover B2, the fifth side S5, the sixth side S6, the seventh side S7, and the eighth side S8 may surround the second back cover B2.

According to various embodiments, an integrated or single structure (e.g., a single continuous structure or a complete structure) replacing the second back cover B2 and the second frame F2 may be provided (or formed).

According to various embodiments, the third housing 23 may include a third frame (also referred to as a third frame structure or a third framework) F3, and a third back cover (also referred to as a third rear cover, a third rear plate, or a third back plate) B3 disposed in (or coupled to) the third frame F3. The third frame F3 may provide (or form) at least a portion of a third side area of the exterior of the multi-foldable electronic device 2. The third back cover B3 may provide (or form) at least a portion of a third rear area of the exterior of the multi-foldable electronic device 2. The third display area 33 of the first display module 3 may provide (or form) at least a portion of a third front area of the multi-foldable electronic device 2, and the third back cover B3 may provide (or form) a third rear area of the third housing 23 facing in the direction opposite to the third front area. When viewed from above the third display area 33 of the first display module 3 or when viewed from above the third front area of the multi-foldable electronic device 2, it may be understood as when viewed in a direction orthogonal to the third display area 33 of the first display module 3 or when viewed in a direction orthogonal to the third front area of the multi-foldable electronic device 2. When viewed from above the third back cover B3 or when viewed from above the third rear area of the third housing 23, it may be understood as when viewed in a direction perpendicular to the third back cover B3 or when viewed in a direction perpendicular to the third rear area of the third housing 23.

According to various embodiments, the third frame F3 of the third housing 23 may include a third side member (also referred to as a third lateral member, a third side structure, or a third side bezel structure) F32. The third side member F32 may provide (or form) at least a portion of a third side area of the exterior of the foldable electronic device 2. The third frame F3 may include a third bracket (also referred to as a third support plate, a third support member, a third support structure, or a third support portion) F31 extended from or connected to the third side member F32. The third frame F3 may be provided (or formed) as an integrated or single structure (e.g., a single continuous structure or a complete structure) including the third side member F32 and the third bracket F31. The third frame F3 may be provided (or formed) by a combination of a conductor (or metal body) (not separately illustrated) including one or more conductive portions (also referred to as metal portions) and a non-conductor (or non-metal body) (not separately illustrated) including one or more non-conductive portions (also referred to as non-metal portions). The third bracket F31 may be a structural element positioned inside the multi-foldable electronic device 2 corresponding to the third housing 23. The third bracket F31 may be positioned at least partially between the third display area 33 of the first display module 3 and the third back cover B3 of the third housing 23. Various members related to electrical elements such as the third display area 33 of the first display module 3, at least one third PCB (e.g., at least one third PCB 513 of FIG. 5), and/or a second battery (e.g., a third battery 523 of FIG. 5) and/or electrical components may be at least partially disposed in or coupled to the third frame F3 (e.g., the third bracket F31) between the third frame F3 and the third back cover B3.

According to various embodiments, the third side member F32 of the third frame F3 may include a ninth side (also referred to as a ninth side portion) S9, a tenth side (also referred to as a tenth side portion) S10, an eleventh side (also referred to as an eleventh side portion) S11, and a twelfth side (also referred to as a twelfth side portion) S12. The ninth side S9 and the tenth side S10 may have lengths extending in a direction parallel to the first center line A1 and the second center line A2. The ninth side S9 may be positioned closer to the first center line A1 than the tenth side S10, and the tenth side S10 may be positioned closer to the second center line A2 than the ninth side S9. The eleventh side S11 may extend from one end of the ninth side S9 and one end of the tenth side S10, or may connect one end of the ninth side S9 and one end of the tenth side S10. The twelfth side S12 may extend from the other end of the ninth side S9 and the other end of the tenth side S10, or may connect the other end of the ninth side S9 and the other end of the tenth side S10. The eleventh side S11 and the twelfth side S12 may have a length extending in a direction perpendicular to the first center line A1 and the second center line A2. The eleventh side S11 and the twelfth side S12 may be perpendicular to the ninth side S9 and the tenth side S10. A corner between the ninth side S9 and the eleventh side S11, a corner between the ninth side S9 and the twelfth side S12, a corner between the tenth side S10 and the eleventh side S11, and/or a corner between the tenth side S10 and the twelfth side S12 may be provided (or formed) as a smooth curve. When viewed from above the third back cover B3, the ninth side S9, the tenth side S10, the eleventh side S11, and the twelfth side S12 may surround the third back cover B3.

According to various embodiments, an integrated or single structure (e.g., a single continuous structure or a complete structure) replacing the third back cover B3 and the third frame F3 may be provided (or formed).

According to various embodiments, in the unfolded state of the multi-foldable electronic device 2, the first side S1, the third side S3, and the fourth side S4 of the first frame F1, the fifth side S5, the seventh side S7, and the eighth side S8 of the second frame F2, and the eleventh side S11 and the twelfth side S12 of the third frame F3 may become a bezel (or screen bezel) surrounding the first display module 3. In the unfolded state of the multi-foldable electronic device 2, when viewed from above the first display area 31 of the first display module 3, the second side S2 of the first frame F1, the sixth side S6 of the second frame F2, and the ninth side S9 and the tenth side S10 of the third frame F3 may not be visually exposed.

According to various embodiments, in the folded state of the multi-foldable electronic device 2, when viewed from above the first back cover B1, the third side S3 of the first frame F1, the seventh side S7 of the second frame F2, and the eleventh side S11 of the third frame F3 may be aligned and overlapped with one another, and the seventh side S7 may be positioned between the third side S3 and the eleventh side S11. In the folded state of the multi-foldable electronic device 2, when viewed from above the first back cover B1, the fourth side S4 of the first frame F1, the eighth side S8 of the second frame F2, and the twelfth side S12 of the third frame F3 may be aligned and overlapped with one another, and the eighth side S8 may be positioned between the fourth side S4 and the twelfth side S12.

According to various embodiments, in the folded state of the multi-foldable electronic device 2, when viewed from above the first back cover B1, a first non-metallic portion D1 of the first side member F12, a sixth non-metallic portion D6 of the second side member F22, and a tenth non-metallic portion D10 of the third side member F32 may be aligned and overlapped with one another. In the folded state of the multi-foldable electronic device 2, when viewed from above the first back cover B1, a second non-metallic portion D2 of the first side member F12, a fifth non-metallic portion D5 of the second side member F22, and a ninth non-metallic portion D9 of the third side member F32 may be aligned and overlapped with one another. In the folded state of the multi-foldable electronic device 2, when viewed from above the first back cover B1, a third non-metallic portion D3 of the first side member F12, an eighth non-metallic portion D8 of the second side member F22, and a twelfth non-metallic portion D12 of the third side member F32 may be aligned and overlapped with one another. In the folded state of the multi-foldable electronic device 2, when viewed from above the first back cover B1, a fourth non-metallic portion D4 of the first side member F12, a seventh non-metallic portion D7 of the second side member F22, and an eleventh non-metallic portion D11 of the third side member F32 may be aligned and overlapped with one another. In the folded state of the multi-foldable electronic device 2, the non-metallic portions of the first side member F12, the second side member F22, and the third side member F32 may be aligned and overlapped with one another, and this alignment and overlapping may reduce electromagnetic interference among the first side member F12, the second side member F22, and the third side member F32 in the case that at least one metal portion included in the first side member F12, the second side member F22, and/or the third side member F32 is configured to operate as an antenna radiator, thereby reducing degradation of antenna radiation performance.

According to various embodiments, the first hinge part H1 may include at least one first hinge (not separately illustrated) and a first hinge cover (also referred to as a first hinge housing) 411. The at least one first hinge may be connected to the first bracket F11 of the first frame F1 included in the first housing 21 and the third bracket F31 of the third frame F3 included in the third housing 23. The first hinge cover 411 may be coupled with at least one first hinge. The first hinge cover 411 may reduce or prevent visual exposure of internal components such as at least one first hinge through a gap between the first frame F1 and the third frame F3 (e.g., a gap between the second side S2 and the ninth side S9).

According to various embodiments, the second hinge part H2 may include at least one second hinge (not separately illustrated) and a second hinge cover (also referred to as a second hinge housing) 412. The at least one second hinge may be connected to the second bracket F21 of the second frame F2 included in the second housing 22 and the third bracket F31 of the third frame F3 included in the third housing 23. The second hinge cover 412 may be coupled with the at least one second hinge. The second hinge cover 412 may reduce or prevent visual exposure of internal components such as at least one second hinge through a gap between the second frame F2 and the third frame F3 (e.g., a gap between the sixth side S6 and the tenth side S10).

According to various embodiments, the multi-foldable electronic device 2 may have an external appearance of a bar type electronic device in the folded state. The multi-foldable electronic device 2 in the folded state may have a front surface formed at least partially by the first back cover B1. The multi-foldable electronic device 2 in the folded state may have a rear surface formed at least partially by the third back cover B3. The multi-foldable electronic device 2 in the folded state may have a first side surface formed at least partially by the first hinge cover 411 of the first hinge part H1. The multi-foldable electronic device 2 in the folded state may have a second side surface formed by the first side S1 of the first frame F1 and the second hinge cover 412. The multi-foldable electronic device 2 in the folded state may have a third side surface formed by the third side S3 of the first frame F1, the seventh side S7 of the second frame F2, and the eleventh side S11 of the third frame F3. The multi-foldable electronic device 2 in the folded state may have a fourth side surface formed by the fourth side S4 of the first frame F1, the eighth side S8 of the second frame F2, and the twelfth side S12 of the third frame F3.

According to various embodiments, because the first hinge part H1 and the second hinge part H2 are configured such that the second housing 22 is positioned between the first housing 21 and the third housing 23 in the folded state of the multi-foldable electronic device 2, the second bendable display area 35 may be bent with a smaller radius of curvature than that of the first bendable display area 34. The second hinge part H2 may be configured to reduce or prevent damage to the second bendable display area 35 in the folded state of the multi-foldable electronic device 2. In various embodiments, the second hinge part H2 may include a first plate (also referred to as a first hinge plate or a first wing plate) 421 (see FIG. 4B) and a second plate (also referred to as a second hinge plate or a second wing plate) 422 (see FIG. 4B). The first plate 421 and the second plate 422 may be operatively connected to at least one second hinge of the second hinge part H2. The second bendable display area 35 of the first display module 3 may be disposed in a bent shape (e.g., a water drop shape or a dumbbell shape) supported by the first plate 421 and the second plate 422 between the first plate 421 and the second plate 422 in the folded state of the multi-foldable electronic device 2 to reduce a bending stress and/or buckling phenomenon. The second bendable display area 35 of the first display module 3 may be supported by the first plate 421 and the second plate 422 in the unfolded state of the multi-foldable electronic device 2 to be disposed flat.

According to various embodiments, the multi-foldable electronic device 2 may include a second display module 4 (e.g., the display module 160 of FIG. 1). The second display module 4 may be positioned between the first back cover B1 and the first bracket F11 of the first frame F1. The second display module 4 may be disposed in or coupled to the first back cover B1 and/or the first bracket F11. A display area (e.g., an active area or a screen area capable of displaying an image based on an electrical signal) of the second display module 4 may be visible through the first back cover B1. In various embodiments, the first back cover B1 may include a transparent area (also referred to as a light transmitting area) corresponding to the display area of the second display module 4, and an opaque area surrounding the transparent area. The display area of the second display module 4 may be visible through the transparent area of the first back cover B1. The multi-foldable electronic device 2 may be configured to display an image through the second display module 4 instead of the first display module 3 in the folded state.

According to various embodiments, the foldable electronic device 1 may include a first camera module 51, a second camera module 52, a third camera module 53, and/or a fourth camera module 54. The first camera module 51, the second camera module 52, the third camera module 53, and/or the fourth camera module 54 may include a camera including one or more lenses, an image sensor(s), and/or an image signal processor (ISP). The first camera module 51, the second camera module 52, the third camera module 53, and/or the fourth camera module 54 may include the camera module 180 of FIG. 1.

According to various embodiments, the first camera module 51 may be, for example, accommodated in the second housing 22 corresponding to the second back cover B2. The second display module 4 may include an opening corresponding to the first camera module 51. The first camera module 51 may be positioned in alignment with the opening of the second display module 4 or may be at least partially inserted into the opening. External light may pass through the second back cover B2 and the opening of the second display module 4 to reach the first camera module 51. The opening of the second display module 4 aligned or overlapped with the first camera module 51 may be a through hole. In various embodiments, the opening of the second display module 4 aligned or overlapped with the first camera module 51 may be provided (or formed) as a notch (not separately illustrated). In various embodiments, although not separately illustrated, the first camera module 51 may overlap with the display area of the second display module 4, when viewed from above the first front area of the foldable electronic device 1. The first camera module 51 may be positioned on the rear surface of the display area of the second display module 4 or under the display area of the second display module 4. When viewed from the outside of the multi-foldable electronic device 2, the first camera module 51 or the position of the first camera module 51 may not be substantially visually distinguished (or exposed). The first camera module 51 may include, for example, a hidden display rear camera (e.g., an under display camera (UDC)). External light may pass through the second display module 4 to reach the first camera module 51.

According to various embodiments, the second camera module 52, the third camera module 53, and the fourth camera module 54 may be accommodated in the third housing 23 corresponding to the third back cover B3. The third back cover B3 may include a first camera hole (or a first light transmitting area) corresponding to the second camera module 52, a second camera hole (or a second light transmitting area) corresponding to the third camera module 53, and/or a third camera hole (or a third light transmitting area) corresponding to the fourth camera module 54. The position or number of the camera modules accommodated in the third housing 23 corresponding to the third back cover B3 is not limited to the illustrated examples.

According to various embodiments, the multi-foldable electronic device 2 may include a light emitting module 55. The light emitting module 55 may be accommodated in the third housing 23 corresponding to the third back cover B3. The third back cover B3 may include a flash hole (or a fourth light transmitting area) corresponding to the light emitting module 55. The light emitting module 55 may include, for example, an LED or a xenon lamp. The light emitting module 55 may include a light source for the second camera module 52, the third camera module 53, and/or the fourth camera module 54.

According to various embodiments, the multi-foldable electronic device 2 may include at least one sound input module (not separately illustrated). The sound input module may include a microphone (also referred to as a microphone). The microphone may be, for example, positioned inside the multi-foldable electronic device 2 corresponding to a microphone hole included in the first side member F12 of the first housing 21, the second side member F22 of the second housing 22, or the third side member F32 of the third housing 23.

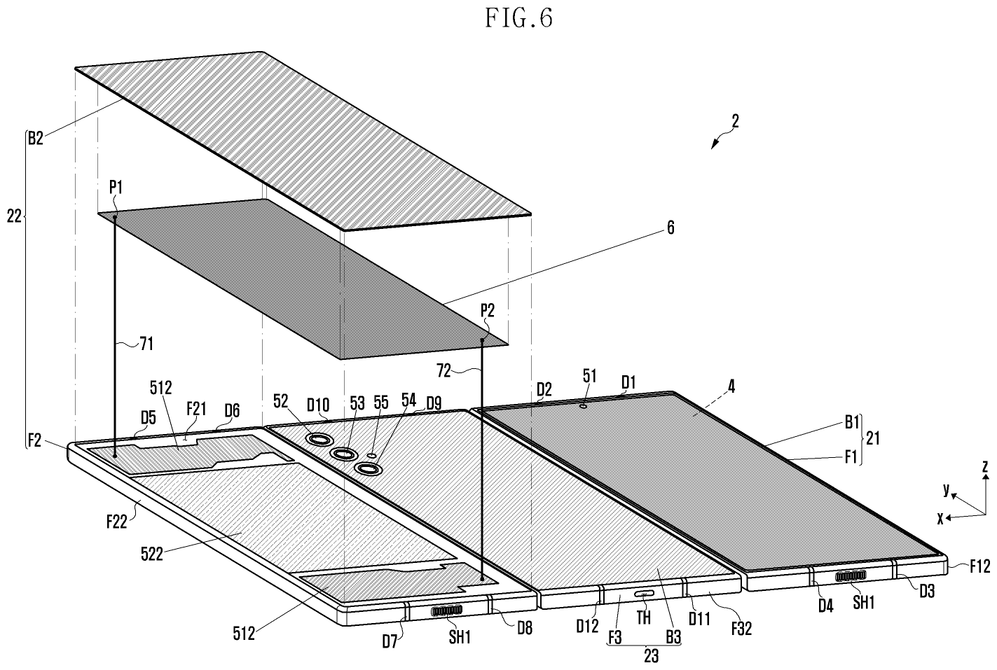

According to various embodiments, the multi-foldable electronic device 2 may include a plurality of sound output modules (not separately illustrated). Any one of the plurality of sound output modules may include a speaker for multimedia playback or recording playback. The speaker for multimedia playback or recording playback may be, for example, positioned inside the multi-foldable electronic device 2 corresponding to a speaker hole (e.g., a first speaker hole SH1 formed in the first side member F12 of FIG. 6 and/or a second speaker hole SH2 formed in the second side member F12 of FIG. 6) included in the first side member F12 of the first housing 21, the second side member F22 of the second housing 22, or the third side member F32 of the third housing 23. Any one of the plurality of sound output modules may include a receiver for a call. The receiver for a call may be, for example, accommodated in the second housing 22 corresponding to a receiver hole formed in a non-display area of the second display module 4. The non-display area of the second display module 4 may surround the display area of the second display module 4.

According to various embodiments, the multi-foldable electronic device 2 may include a key input module. The key input module may include a first key (also referred to as a first side key) 56 and/or a second key (also referred to as a second side key) 57. The key input module may include a key signal generator (not separately illustrated). For example, the first key 56 may be positioned in a first key hole included in the first side member F12 of the first housing 21, and the second key 57 may be positioned in a second key hole included in the first side member F12 of the first housing 21. The key signal generator may be configured to generate a key signal in response to a press or touch on the first key 56 and/or the second key 57. The position or number of key input modules is not limited to the illustrated examples.

According to various embodiments, the multi-foldable electronic device 2 may include at least one connection terminal (also referred to as a connector or interface terminal). The at least one connection terminal may be, for example, positioned inside the multi-foldable electronic device 2 corresponding to a connection terminal hole (e.g., a connector hole) (e.g., a terminal hole (TH) formed in a third side member F32 of FIG. 6) included in the first side member F12 of the first housing 21, the second side member F22 of the second housing 22, or the third side member F32 of the third housing 23. The multi-foldable electronic device 2 may be configured to transmit and/or receive power and/or data to/from an external electronic device electrically connected to at least one connection terminal (e.g., a USB connector or an HDMI connector). An external storage medium, such as a secure digital memory (SD) card, a SIM card, or a universal SIM (USIM) card, may be connected to at least one connection terminal (e.g., a connector for external storage medium).

According to various embodiments, the multi-foldable electronic device 2 may include a ground structure (not separately illustrated). The ground structure of the multi-foldable electronic device 2 may be configured to reduce or prevent electromagnetic interference (EMI) to electrical elements included in the multi-foldable electronic device 2. The ground structure of the multi-foldable electronic device 2 may be configured to reduce or prevent electromagnetic influence of noise from the outside of the multi-foldable electronic device 2 on electrical elements included in the multi-foldable electronic device 2. The ground structure of the multi-foldable electronic device 2 may be configured to reduce or prevent electromagnetic interference between electrical elements included in the multi-foldable electronic device 2.

According to various embodiments, the ground structure of the multi-foldable electronic device 2 may include a first conductor (also referred to as a first conductive structure or a first metal structure) included in the first housing 21. The first frame F1 may include a first outer metal portion (also referred to as a first outer metal structure) included in the first side member F12, and a first outer non-metal portion (also referred to as a first outer non-metal structure) included in the first side member F12 and coupled (e.g., bonded) to the first outer metal portion. For example, the first outer metal portion may include a plurality of metal portions (also referred to as conductive portions) and first segmented portions (also referred to as first gaps) between the plurality of metal portions, and the first outer non-metal portion may include a plurality of non-metal portions (also referred to as non-conductive portions) disposed (e.g., filled) in the first segmented portions of the first outer metal portion. The plurality of non-metal portions may include, for example, a first non-metal portion D1 and a second non-metal portion D2 included in the third side S3, and a third non-metal portion D3 and a fourth non-metal portion D4 included in the fourth side S4. Positions or numbers of the plurality of metal portions and the plurality of non-metal portions included in the first side member F12 are not limited to the illustrated examples. The first frame F1 may include a first inner metal portion (also referred to as a first inner metal structure) included in the first bracket F11, and a first inner non-metal portion (also referred to as a first inner non-metal structure) included in the first bracket F11 and coupled (e.g., bonded) to the first inner metal portion. The first frame F1 may include an integrated or single structure (e.g., a single continuous structure or a complete structure) including the first outer non-metal portion and the first inner non-metal portion. The first frame F1 may include an integral or single structure (e.g., a single continuous structure or a complete structure) including the first outer non-metal portion and the first inner non-metal portion. The first conductor included in the first housing 21 of the ground structure of the multi-foldable electronic device 2 may include a first outer metal portion and a first inner metal portion of the first frame F1, but is not limited thereto.

According to various embodiments, the ground structure of the multi-foldable electronic device 2 may include a second conductor (also referred to as a second conductive structure or a second metal structure) included in the second housing 21. The second frame F2 may include a second outer metal portion (also referred to as a second outer metal structure) included in the second side member F22, and a second outer non-metal portion (also referred to as a second outer non-metal structure) included in the second side member F22 and coupled (e.g., bonded) to the second outer metal portion. For example, the second outer metal portion may include a plurality of metal portions (referred to as conductive portions) and second segmented portions (also referred to as second gaps) between the plurality of metal portions, and the second outer non-metal portion may include a plurality of non-metal portions (referred to as non-conductive portions) disposed (e.g., filled) in the second segmented portions of the second outer metal portion. The plurality of non-metal portions may include, for example, a fifth non-metal portion D5 and a sixth non-metal portion D6 included in the seventh side S7, and a seventh non-metal portion D7 and an eighth non-metal portion D8 included in the eighth side S8. Positions or numbers of the plurality of metal portions and the plurality of non-metal portions included in the second side member F22 are not limited to the illustrated examples. The second frame F2 may include a second inner metal portion (also referred to as a second inner metal structure) included in the second bracket F21, and a second inner non-metal portion (also referred to as a second inner non-metal structure) included in the second bracket F21 and coupled (e.g., bonded) to the second inner metal portion. The second frame F2 may include an integrated or single structure (e.g., a single continuous structure or a complete structure) including the second outer non-metal portion and the second inner non-metal portion. The second frame F2 may include an integral or single structure (e.g., a single continuous structure or a complete structure) including the second outer non-metal portion and the second inner non-metal portion. The second conductor included in the second housing 22 of the ground structure of the multi-foldable electronic device 2 may include, but is not limited to, the second outer metal portion and the second inner metal portion of the second frame F2.

According to various embodiments, the ground structure of the multi-foldable electronic device 2 may include a third conductor (also referred to as a third conductive structure or a third metal structure) included in the third housing 23. The third frame F3 may include a third outer metal portion (also referred to as a third outer metal structure) included in the third side member F32, and a third outer non-metal portion (also referred to as a third outer non-metal structure) included in the third side member F32 and coupled (e.g., bonded) to the third outer metal portion. For example, the third outer metal portion may include a plurality of metal portions (referred to as conductive portions) and third segmented portions (also referred to as third gaps) between the plurality of metal portions, and the third outer non-metal portion may include a plurality of non-metal portions (referred to as non-conductive portions) disposed (e.g., filled) in the third segmented portions of the third outer metal portion. The plurality of non-metal portions may include, for example, a ninth non-metal portion D9 and a tenth non-metal portion D10 included in the eleventh side S11, and an eleventh non-metal portion D11 and a twelfth non-metal portion D12 included in the twelfth side S12. Positions or numbers of the plurality of metal portions and the plurality of non-metal portions included in the third side member F32 are not limited to the illustrated examples. The third frame F3 may include a third inner metal portion (also referred to as a third inner metal structure) included in the third bracket F31, and a third inner non-metal portion (also referred to as a second inner non-metal structure) included in the third bracket F31 and coupled (e.g., bonded) to the third inner metal portion. The third frame F3 may include an integrated or single structure (e.g., a single continuous structure or a complete structure) including the third outer non-metal portion and the third inner non-metal portion. The third frame F3 may include an integral or single structure (e.g., a single continuous structure or a complete structure) including the third outer non-metal portion and the third inner non-metal portion. The third conductor included in the third housing 23 of the ground structure of the multi-foldable electronic device 2 may include, but is not limited to, the third outer metal portion and the third inner metal portion of the third frame F3.

According to various embodiments, the ground structure of the multi-foldable electronic device 2 may include a fourth conductor (also referred to as a fourth conductive structure or a fourth metal structure) included in the first hinge part H1.

According to various embodiments, the ground structure of the multi-foldable electronic device 2 may include a fifth conductor (also referred to as a fifth conductive structure or a fifth metal structure) included in the second hinge part H2.

According to various embodiments, the ground structure of the multi-foldable electronic device 2 may include a sixth conductor (also referred to as a sixth conductive structure or a sixth metal structure) included in one or more PCBs (e.g., a rigid PCB, a flexible PCB (FPCB), or a rigid-flexible PCB (RFPCB)) included in the multi-foldable electronic device 2. The sixth conductor may include, for example, one or more ground areas included in the PCB.

According to various embodiments, the ground structure of the multi-foldable electronic device 2 may include a seventh conductor (also referred to as a seventh conductive structure or a seventh metal structure) included in the first display module 3. The seventh conductor may include a ground plane (also referred to as a ground layer) of the first display module 3. The ground plane of the first display module 3 may include, for example, an electromagnetic shielding layer of a metal material that forms at least a portion of a rear surface of the first display module 3 or disposed in at least a portion of a rear surface of the first display module 3.

According to various embodiments, the ground structure of the multi-foldable electronic device 2 may include an eighth conductor (also referred to as an eighth conductive structure or an eighth metal) (not separately illustrated) included in the second display module 4. The eighth conductor may include a ground plane (also referred to as a ground layer) of the second display module 4. The ground plane of the second display module 4 may include, for example, an electromagnetic shielding layer of a metal material that forms at least a portion of a rear surface of the second display module 4 or disposed in at least a portion of a rear surface of the second display module 4.

According to various embodiments, a first conductor of the first housing 21, a second conductor of the second housing 22, a third conductor of the third housing 23, a fourth conductor of the first hinge part H1, a fifth conductor of the second hinge part H2, a sixth conductor of one or more PCBs, a seventh conductor of the first display module 3, and an eighth conductor of the second display module 4 may be electrically connected. According to various embodiments, at least two of the first conductor, the second conductor, the third conductor, the fourth conductor, the fifth conductor, the sixth conductor, the seventh conductor, and the eighth conductor may be directly electrically connected via physical contact. According to various embodiments, at least two of the first conductor, the second conductor, the third conductor, the fourth conductor, the fifth conductor, the sixth conductor, the seventh conductor, and the eighth conductor may be indirectly electrically connected via a separate electrical connecting member.

According to various embodiments, the first conductor of the first housing 21 and the third conductor of the third housing 23 may be electrically connected via the fourth conductor of the first hinge part H1, and/or electrically connected via an electrical connection member (e.g., FPCB) disposed across the first hinge part H1. The fourth conductor of the first hinge part H1 may be electrically connected to the first conductor of the first housing 21 and the third conductor of the third housing 23 through mechanical fastening such as screw fastening, or physical contact. The second conductor of the second housing 22 and the third conductor of the third housing 23 may be electrically connected via the fifth conductor of the second hinge part H2 and/or electrically connected via an electrical connection member (e.g., FPCB) disposed across the second hinge part H2. The fifth conductor of the second hinge part H2 may be electrically connected to the first conductor of the first housing 21 and the third conductor of the third housing 23 through mechanical fastening such as screw fastening or physical contact.

According to various embodiments, the first conductor of the first housing 21 and the sixth conductor of one or more PCBs may be electrically connected via an electrical connection member, such as a flexible conductive member (e.g., a conductive clip (e.g., a conductive structure including a resilient structure), pogo-pin, spring, conductive poron, conductive sponge, or conductive rubber), a conductive adhesive member (e.g., conductive tape), or a conductive connector, disposed between the first conductor and the sixth conductor. The second conductor of the second housing 22 and the sixth conductor of the one or more PCBs may be electrically connected via an electrical connection member, such as a flexible conductive member, a conductive adhesive member, or a conductive connector, disposed between the second conductor and the sixth conductor. The third conductor of the third housing 23 and the sixth conductor of the one or more PCBs may be electrically connected via an electrical connection member, such as a flexible conductive member, a conductive adhesive member, or a conductive connector, disposed between the third conductor and the sixth conductor.

According to various embodiments, the first conductor of the first housing 21 and the seventh conductor of the first display module 3 may be electrically connected via an electrical connection member, such as a flexible conductive member, a conductive adhesive member, or a conductive connector, disposed between the first conductor and the seventh conductor. The second conductor of the second housing 22 and the seventh conductor of the first display module 3 may be electrically connected via an electrical connection member, such as a flexible conductive member, a conductive adhesive member, or a conductive connector, disposed between the second conductor and the seventh conductor. The third conductor of the third housing 23 and the seventh conductor of the first display module 3 may be electrically connected via an electrical connection member, such as a flexible conductive member, a conductive adhesive member, or a conductive connector, disposed between the third conductor and the seventh conductor.

According to various embodiments, the first conductor of the first housing 21 and the eighth conductor of the second display module 4 may be electrically connected via an electrical connection member, such as a flexible conductive member, a conductive adhesive member, or a conductive connector, disposed between the first conductor and the eighth conductor.

According to various embodiments, the seventh conductor of the first display module 3 and the sixth conductor of one or more PCBs may be electrically connected via an electrical connection member, such as a flexible conductive member, a conductive adhesive member, or a conductive connector, disposed between the seventh conductor and the sixth conductor. The seventh conductor of the first display module 3 and the sixth conductor of one or more PCBs may be electrically connected via an electrical connection member, such as an FPCB, that electrically connects the first display module 3 and the one or more PCBs.

According to various embodiments, the eighth conductor of the second display module 4 and the sixth conductor of the one or more PCBs may be electrically connected via an electrical connection member, such as a flexible conductive member, a conductive adhesive member, or a conductive connector, disposed between the eighth conductor and the sixth conductor. The eighth conductor of the second display module 4 and the sixth conductor of the one or more PCBs may be electrically connected via an electrical connection member, such as an FPCB, that electrically connects the second display module 4 and the one or more PCBs.

According to various embodiments, the sixth conductor of one or more PCBs may include a plurality of ground areas of the plurality of PCBs, and the plurality of ground areas may be electrically connected via an electrical connection member (e.g., FPCB). For example, one of two PCBs may be positioned in the first housing 21, and the other may be positioned in the third housing 23, and the two PCBs may be electrically connected via an electrical connection member (e.g., FPCB) disposed across the first hinge part H1. For example, one of the two PCBs may be positioned in the second housing 22, the other may be positioned in the third housing 23, and the two PCBs may be electrically connected via an electrical connection member (e.g., FPCB) disposed across the second hinge part H2.

According to various embodiments, the ground structure of the multi-foldable electronic device 2 is not limited to the first conductor, the second conductor, the third conductor, the fourth conductor, the fifth conductor, the sixth conductor, the seventh conductor, and the eighth conductor, and may vary.

According to various embodiments, the multi-foldable electronic device 2 may include a first conductive area (not separately illustrated) and a second conductive area (not separately illustrated). The first conductive area and the second conductive area may be electrically connected or may be electrically and physically connected. According to various embodiments of the disclosure, in the case that the first conductive area is configured to substantially radiate electromagnetic waves, the first conductive area, in the combination of the first conductive area and the second conductive area, may be defined or understood as a radiating portion (or antenna radiating portion, radiator, or antenna radiator), and the second conductive area, in the combination of the first conductive area and the second conductive area, may be interpreted or understood as a ground structure of the multi-foldable electronic device 2, which is distinct from the radiating portion. According to various embodiments of the disclosure, in the case that the first conductive area is configured to substantially radiate electromagnetic waves, a combination of the first conductive area and the second conductive area may be interpreted or understood as a ground structure of the multi-foldable electronic device 2, and the first conductive area may be interpreted or understood as a radiating portion implemented through a part of the ground structure of the multi-foldable electronic device 2. According to various embodiments of the disclosure, in the case that the first conductive area is configured to substantially radiate electromagnetic waves, the second conductive area may operate as an antenna ground that electromagnetically affects the first conductive area (e.g., antenna radiator). The antenna ground may contribute to securing antenna radiation performance (or radio transmission and reception performance or communication performance) and/or securing coverage with respect to the antenna radiator. The antenna ground may reduce electromagnetic interference (EMI) or signal loss with respect to the radiating portion.

According to various embodiments, some of the ground structures of the multi-foldable electronic device 2 may be configured to operate as a radiating portion (or antenna radiating portion, radiator, or antenna radiator). Some of the ground structures of the multi-foldable electronic device 2 may be electrically connected to the wireless communication circuit (e.g., the wireless communication module 192 of FIG. 1) disposed on a PCB. Some of the ground structures of the multi-foldable electronic device 2 may receive (or feed) an electromagnetic signal (or a wireless signal, a radio frequency (RF) signal, or a radiating current) from the wireless communication circuit and operate as a radiating portion (e.g., resonator). Other parts of the ground structures of the multi-foldable electronic device 2 may be formed as antenna grounds that electromagnetically affect at least one antenna radiator.

According to various embodiments, the multi-foldable electronic device 2 may be configured to transmit and/or receive an electromagnetic signal through at least a portion of a first outer metal portion included in the first side member F12 of the first housing 21. The multi-foldable electronic device 2 may be configured to transmit and/or receive an electromagnetic signal through at least a portion of a second outer metal portion included in the second side member F22 of the second housing 22. The multi-foldable electronic device 2 may be configured to transmit and/or receive an electromagnetic signal through at least a portion of a third outer metal portion included in the third side member F32 of the third housing 23. A portion of the ground structure configured to operate as an antenna radiator may also vary.

According to various embodiments, the wireless communication circuit (e.g., the wireless communication module 192 of FIG. 1) may process a transmitting signal or a receiving signal in at least one designated or selected frequency band via at least one radiating portion (or antenna radiating portion, radiator, or antenna radiator). The designated or selected frequency band may include, but is not limited to, for example, a low band (LB) (about 600 MHz (megahertz) to about 1 GHz (gigahertz), a middle band (MB) (about 1 GHz to about 2.3 GHZ), a high band (HB) (about 2.3 GHz to about 2.7 GHZ), or an ultra-high band (UHB) (about 2.7 GHz to about 6 GHz).

According to various embodiments, the multi-foldable electronic device 2 may further include various components according to a provision form thereof. These components may be modified in various ways according to the convergence trend of the multi-foldable electronic device 2 and thus cannot all be listed, but components equivalent to the above-described components may be additionally included in the multi-foldable electronic device 2. In various embodiments, according to the form in which it is provided, certain components among the above-described components may be excluded or replaced with other components.

FIG. 5 is a cross-sectional view illustrating a portion of a multi-foldable electronic device 2 in a folded state taken along line FF′ of FIG. 3A according to various embodiments;

FIG. 6 is a partial exploded perspective view illustrating a multi-foldable electronic device 2 in an unfolded state according to various embodiments;

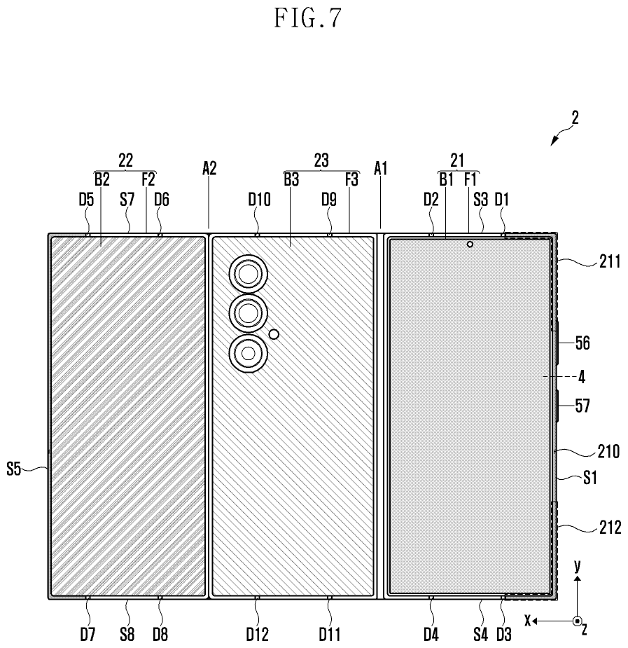

FIG. 7 is a diagram illustrating an unfolded multi-foldable electronic device 2 according to various embodiments;

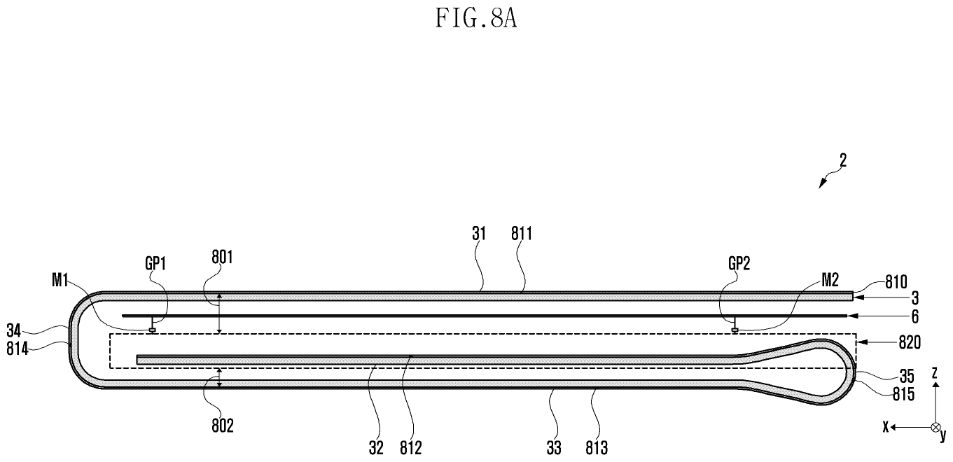

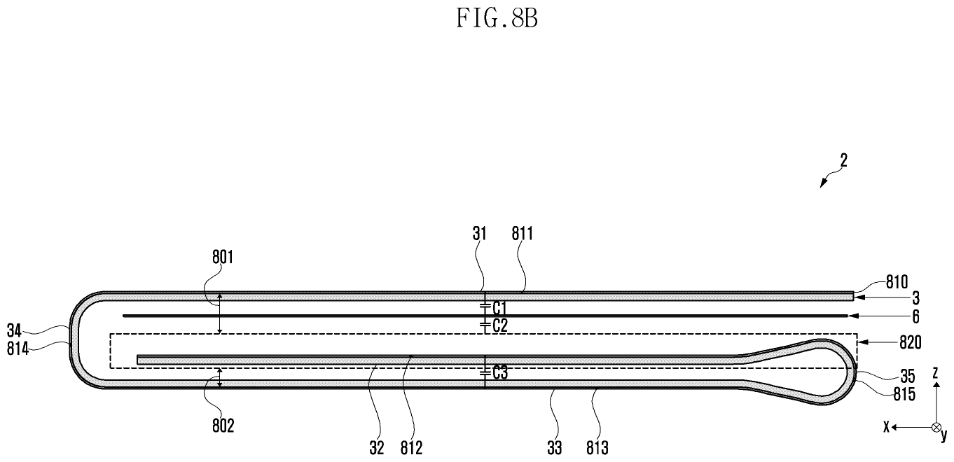

FIG. 8A is a cross-sectional view illustrating a portion of a multi-foldable electronic device 2 in a folded state taken along line EE′ of FIG. 3A according to various embodiments;

FIG. 8B is a cross-sectional view illustrating a portion of a multi-foldable electronic device 2 in a folded state taken along line EE′ of FIG. 3A according to various embodiments;

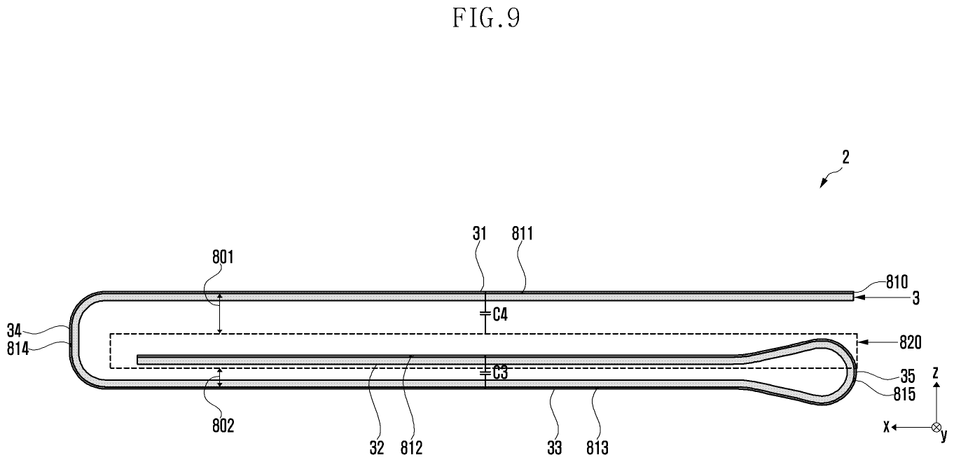

FIG. 9 is a cross-sectional view illustrating a portion of a foldable electronic device 900 of a comparative example for comparison with FIG. 8B according to various embodiments;

It should be understood that various combinations of features and/or embodiments disclosed in connection with FIGS. 5, 6, 7, 8A, and 8B are contemplated and encompassed by the disclosure. Various combinations of features described below in connection with FIGS. 5, 6, 7, 8A, and 8B may be considered to be included in the disclosure as specific examples.

With reference to FIGS. 5, 6, 7, 8A, and 8B, the multi-foldable electronic device 2 may include a first housing 21, a second housing 22, a third housing 23, and a first display module 3. The first housing 21 may include a first frame F1 and a first back cover B1. The first frame F1 may include a first bracket F11 and a first side member F12. The second housing 22 may include a second frame F2 and a second back cover B2. The second frame F2 may include a second bracket F21 and a second side member F22. The third housing 23 may include a third frame F3 and a third back cover B3. The third frame F3 may include a third bracket F31 and a third side member F32. The first display module 3 may include a first display area 31 disposed in or coupled to the first bracket F11, a second display area 32 disposed in or coupled to the second bracket F21, and a third display area 33 disposed in or coupled to the third bracket F31. For example, the multi-foldable electronic device 2 may include a second display module 4. The multi-foldable electronic device 2 may include a first camera module 51, a second camera module 52, a third camera module 53, and/or a fourth camera module 54. The multi-foldable electronic device 2 may include a light emitting module 55. The multi-foldable electronic device 2 may include at least one first PCB 511, at least one second PCB 512, and/or at least one third PCB 513. For example, at least one first PCB 511 may be disposed in or coupled to the first bracket F11 between the first bracket F11 and the first back cover B1. For example, at least one second PCB 512 may be disposed in or coupled to the second bracket F21 between the second bracket F21 and the second back cover B2. For example, at least one third PCB 513 may be disposed in or coupled to the third bracket F31 between the third bracket F31 and the third back cover B3. The multi-foldable electronic device 2 may include a first battery 521, a second battery 522, and/or a third battery 523. For example, the first battery 521 may be disposed in or coupled to the first bracket F11 between the first bracket F11 and the first back cover B1. For example, the second battery 522 may be disposed in or coupled to the second bracket F21 between the second bracket F21 and the second back cover B2. For example, the third battery 523 may be disposed in or coupled to the third bracket F31 between the third bracket F31 and the third back cover B3. Descriptions of some components that are the same as in the previous embodiment may not be repeated.

According to various embodiments, the multi-foldable electronic device 2 may be configured to transmit and/or receive an electromagnetic signal through at least a portion of a first outer metal portion included in the first side member F12 of the first frame F1. The multi-foldable electronic device 2 may be configured to transmit and/or receive an electromagnetic signal through at least a portion of a second outer metal portion included in the second side member F22 of the second housing 22. The multi-foldable electronic device 2 may be configured to transmit and/or receive an electromagnetic signal through at least a portion of a third outer metal portion included in the third side member F32 of the third housing 23.

According to various embodiments, the multi-foldable electronic device 2 may be configured to transmit and/or receive a signal (e.g., electromagnetic signal) of a designated or selected frequency band through at least a portion of the first outer metal portion included in the first side member F12 of the first frame F1 and/or at least a portion of the third outer metal portion included in the third side member F32 of the third frame F3. In the case that at least a portion of the second outer metal portion included in the second side member F22 of the second frame F2 is configured as an antenna radiator, the first housing 21 and the third housing 23 may exert an electromagnetic influence (e.g., electromagnetic interference) on the antenna radiator due to the second housing 22 being positioned between the first housing 21 and the third housing 23 in the folded state of the multi-foldable electronic device 2, thereby degrading antenna radiation performance. In the folded state, using at least a portion of the first outer metal portion included in the first side member F12 of the first frame F1 and/or at least a portion of the third outer metal portion included in the third side member F32 of the third frame F3 as an antenna radiator may be more advantageous in reducing degradation of antenna radiation performance or in securing antenna radiation performance, compared to using at least a portion of the second outer metal portion included in the second side member F22 of the second frame F2 as an antenna radiator.

According to various embodiments, the multi-foldable electronic device 2 may be configured to transmit and/or receive a signal (e.g., electromagnetic signal) of a designated or selected frequency band through a metal portion 210 between the first non-metal portion D1 and the third non-metal portion D3 among first outer metal portions included in the first side member F12 of the first frame F1. The metal portion 210 may include a portion extending from the first side S1 in the first side S1 and the third side S3 to the first non-metal portion D1, and a portion extending from the first side S1 in the first side S1 and the fourth side S4 to the third non-metal portion D3.

According to various embodiments, the multi-foldable electronic device 2 may be configured to transmit and/or receive a signal (e.g., electromagnetic signal) of a designated or selected frequency band through the first partial metal portion 211 and/or the second partial metal portion 212 of the metal portion 210. For example, the first partial metal portion 211 may include a first corner between the first side S1 and the third side S3, a portion of the first side S1 extending from the first corner, and a portion of the third side S3 extending from the first corner to the first non-metal portion D1. For example, the second partial metal portion 212 may include a second corner between the first side S1 and the fourth side S4, a portion of the first side S1 extending from the second corner, and a portion of the fourth side S4 extending from the second corner to the third non-metal portion D3.

According to various embodiments, the first partial metal portion 211 may be configured to operate as an inverted F antenna (IFA) or a planar IFA (PIFA). For example, the first partial metal portion 211 may include a first feeding point (also referred to as a first feeding portion) and a first ground point (also referred to as a first ground portion). The first feeding point of the first partial metal portion 211 may be configured to receive (or feed) an electromagnetic signal from the wireless communication circuit (e.g., the wireless communication module 192 of FIG. 1) of the multi-foldable electronic device 2. The first ground point of the first partial metal portion 211 may be electrically connected to a first ground area included in at least one first PCB 511. The first feeding point of the first partial metal portion 211 may be, for example, electrically connected to at least one first PCB 511 via an electrical connection member such as a flexible conductive member, a conductive adhesive member, or a conductive connector disposed (e.g., surface-mounted) on at least one first PCB 511. The first ground point of the first partial metal portion 211 may be, for example, electrically connected to at least one first PCB 511 via an electrical connection member such as a flexible conductive member, a conductive adhesive member, or a conductive connector disposed (e.g., surface-mounted) on at least one first PCB 511. When a wireless communication circuit provides (or feeds) an electromagnetic signal to the first feeding point of the first partial metal portion 211, a current path (also referred to as a signal path) in which a current (also referred to as a radiation current) flows through the first partial metal portion 211 between the first feeding point and the first ground point may be formed. The distribution of the current along the current path may enable an electromagnetic field (also referred to as a radiation field) (or magnetic field distribution) capable of transmitting a signal in a designated frequency band through the first partial metal portion 211 to be generated (or formed). In various embodiments, the first feeding point may be implemented in multiple numbers. In various embodiments, the first ground point may be implemented in multiple numbers.

According to various embodiments, the second partial metal portion 212 may be configured to operate as an IFA or a PIFA. For example, the second partial metal portion 212 may include a second feeding point (also referred to as a second feeding portion) and a second ground point (also referred to as a second ground portion). The second feeding point of the second partial metal portion 212 may be configured to receive (or feed) an electromagnetic signal from the wireless communication circuit (e.g., the wireless communication module 192 of FIG. 1) of the multi-foldable electronic device 2. The second ground point of the second partial metal portion 212 may be electrically connected to a first ground area included in at least one first PCB 511. The second feeding point of the second partial metal portion 212 may be, for example, electrically connected to at least one first PCB 511 via an electrical connection member such as a flexible conductive member, a conductive adhesive member, or a conductive connector disposed (e.g., surface-mounted) on at least one first PCB 511. The second ground point of the second partial metal portion 212 may be, for example, electrically connected to at least one first PCB 511 via an electrical connection member such as a flexible conductive member, a conductive adhesive member, or a conductive connector disposed (e.g., surface-mounted) on at least one first PCB 511. When the wireless communication circuit provides (or feeds) an electromagnetic signal to the second feeding point of the second partial metal portion 212, a current path (also referred to as a signal path) in which a current (also referred to as a radiation current) flows through the second partial metal portion 212 between the second feeding point and the second ground point may be formed. The distribution of the current along the current path may enable an electromagnetic field (also referred to as a radiation field) (or magnetic field distribution) capable of transmitting a signal in a designated frequency band through the second partial metal portion 212 to be generated (or formed). In various embodiments, the second feeding point may be implemented in multiple numbers. In various embodiments, the second ground point may be implemented in multiple numbers.

According to various embodiments, the wireless communication circuit (e.g., the wireless communication module 192 of FIG. 1) of the multi-foldable electronic device 2 may be disposed (e.g., surface-mounted) on at least one first PCB 511 accommodated in the first housing 21. In various embodiments, the wireless communication circuit may be disposed (e.g., surface-mounted) on at least one second PCB 512 accommodated in the second housing 22. In various embodiments, the wireless communication circuit may be disposed (e.g., surface-mounted) on at least one third PCB 513 accommodated in the third housing 23.

According to various embodiments, the ground structure of the multi-foldable electronic device 2 may include a first ground structure (also referred to as a first ground) positioned in the first housing 21, a second ground structure (also referred to as a second ground) 820 (see FIGS. 8A and 8B) positioned in the second housing 22, and a third ground structure (also referred to as a third ground) positioned in the third housing 23. In the folded state of the multi-foldable electronic device 2, the second ground structure 820 may be positioned between the first ground structure and the third ground structure. In the folded state of the multi-foldable electronic device 2, when viewed from above the first back cover B1, the first ground structure, the second ground structure 820, and the third ground structure may overlap.

According to various embodiments, the first ground structure positioned in the first housing 21 may include, but is not limited to, a first conductor included in the first housing 21, a first ground area (e.g., a portion of the sixth conductor) included in at least one first PCB 511, a portion of a seventh conductor (e.g., a ground plane 810 of FIG. 8A) of the first display module 3, included in the first display area 31, and an eighth conductor (e.g., ground plane) included in the second display module 4. The first conductor included in the first housing 21 may include a first inner metal portion included in the first bracket F11, and a first outer metal portion included in the first side member F12.

According to various embodiments, the second ground structure positioned in the second housing 22 may include, but is not limited to, a second conductor included in the second housing 22, a second ground area (e.g., a portion of the sixth conductor) included in at least one second PCB 512, and a portion of the seventh conductor (e.g., electromagnetic shielding layer) of the first display module 3, included in the second display area 32. The second conductor included in the second housing 22 may include a second inner metal portion included in the second bracket F21, and a second outer metal portion included in the second side member F22.

According to various embodiments, the third ground structure positioned in the third housing 23 may include, but is not limited to, a third conductor included in the third housing 23, a third ground area (e.g., a portion of the sixth conductor) included in at least one third PCB 513, and a portion of the seventh conductor (e.g., electromagnetic shielding layer) of the first display module 3, included in the third display area 33. The third conductor included in the third housing 23 may include a third inner metal portion included in the third bracket F31, and a second outer metal portion included in the third side member F32.

According to various embodiments, a first ground structure positioned in the first housing 21 and a third ground structure positioned in the third housing 23 may be electrically connected. The first ground structure and the third ground structure may be, for example, electrically connected via the fourth conductor included in the first hinge part H1 (see FIG. 2C). The first ground structure and the third ground structure may be, for example, electrically connected via the seventh conductor (e.g., the ground plane 810 of FIGS. 8A and 8B) of the first display module 3 disposed across the first hinge part H1 (see FIG. 2C).

The first ground structure and the third ground structure may be, for example, electrically connected via a separate electrical connecting member (e.g., FPCB) disposed across the first hinge part H1 (see FIG. 2C).

According to various embodiments, a second ground structure positioned in the second housing 22 and a third ground structure positioned in the third housing 23 may be electrically connected. The second ground structure and the third ground structure may be, for example, electrically connected via the fifth conductor included in the second hinge part H2 (see FIG. 2C). The second ground structure and the third ground structure may be, for example, electrically connected via the seventh conductor (e.g., the ground plane 810 of FIGS. 8A and 8B) of the first display module 3 disposed across the second hinge part H2 (see FIG. 2C). The second ground structure and the third ground structure may be, for example, electrically connected via a separate electrical connecting member (e.g., FPCB) disposed across the second hinge part H2 (see FIG. 2C).

According to various embodiments, a portion of the ground structure of the multi-foldable electronic device 2 may be configured to operate as an antenna radiator. For example, a portion (e.g., the first partial metal portion 211 and/or the second partial metal portion 212) of the first ground structure may be configured to be electrically connected to the wireless communication circuit (e.g., the wireless communication module 192 of FIG. 1) to operate as an antenna radiator. For example, a portion of the second ground structure may be configured to be electrically connected to the wireless communication circuit (e.g., the wireless communication module 192 of FIG. 1) to operate as an antenna radiator. For example, a portion of the third ground structure may be configured to be electrically connected to the wireless communication circuit (e.g., the wireless communication module 192 of FIG. 1) to operate as an antenna radiator. At least a portion of the remaining portions of the ground structure, excluding the portion configured to operate as an antenna radiator, may be configured as an antenna ground that electromagnetically affects the antenna radiator. The antenna ground may contribute to securing antenna radiation performance (or radio transmission and reception performance or communication performance) and/or securing coverage with respect to the antenna radiator. The antenna ground may reduce electromagnetic interference (EMI) or signal loss with respect to the radiator.

According to various embodiments, the first ground structure and the third ground structure may be a waveguide structure (e.g., a parallel-plate waveguide (PPW) structure) in the folded state of the multi-foldable electronic device 2. In a first comparative example in which the first ground structure and the third ground structure are not electrically connected, the waveguide structure including the first ground structure and the third ground structure may cause parasitic resonance due to an electromagnetic influence (e.g., electromagnetic coupling) from energy (also referred to as electromagnetic wave energy) radiated from at least one antenna radiator (e.g., the first partial metal portion 211 and/or the second partial metal portion 212). In the first comparative example, a guided wave may be generated as a portion of an electromagnetic wave radiated from at least one antenna radiator is reflected and propagates along a first surface of the first ground structure and a second surface of the second ground structure. In the first comparative example, parasitic resonance (or waveguide resonance) due to the guided wave flowing between the first ground structure and the second ground structure may degrade antenna radiation performance of an antenna including at least one antenna radiator. In the first comparative example, a frequency of parasitic resonance (e.g., a frequency at which parasitic resonance occurs) may fall within the operating frequency band (usage frequency band) of an antenna including at least one antenna radiator, and power leakage caused by this may degrade the antenna radiation performance. According to the disclosure, electrically connecting the first ground structure and the second ground structure may reduce the influence of the waveguide structure on antenna radiation performance of an antenna including at least one antenna radiator. According to the disclosure, electrically connecting the first ground structure and the second ground structure may adjust the frequency of parasitic resonance formed by the waveguide structure so that the frequency of the parasitic resonance does not fall within the operating frequency band of an antenna including at least one antenna radiator. The ‘comparative example’ described in the disclosure is provided solely for comparison with various embodiments of the disclosure and does not have precedence over various embodiments of the disclosure.

According to various embodiments, the second ground structure and the third ground structure may be a waveguide structure (e.g., PPW structure) in the folded state of the multi-foldable electronic device 2. In a second comparative example in which the second ground structure and the third ground structure are not electrically connected, the waveguide structure including the second ground structure and the third ground structure may cause parasitic resonance due to an electromagnetic influence (e.g., electromagnetic coupling) from energy (also referred to as electromagnetic wave energy) radiated from at least one antenna radiator (e.g., the first partial metal portion 211 and/or the second partial metal portion 212). In the second comparative example, a guided wave may be generated as a portion of the electromagnetic wave radiated from at least one antenna radiator is reflected and propagates along the second surface of the second ground structure and the third surface of the third ground structure. In the second comparative example, parasitic resonance (or waveguide resonance) caused by a guided wave flowing between the second ground structure and the third ground structure may degrade antenna radiation performance of an antenna including at least one antenna radiator. In the second comparative example, the frequency of parasitic resonance (e.g., the frequency at which parasitic resonance occurs) may fall within the operating frequency band of an antenna including at least one antenna radiator, and power leakage caused by this may degrade antenna radiation performance. According to the disclosure, electrically connecting the second ground structure and the third ground structure may reduce an influence of the waveguide structure on antenna radiation performance of an antenna including at least one antenna radiator. According to the disclosure, electrically connecting the second ground structure and the third ground structure may adjust the frequency of parasitic resonance formed by the waveguide structure so that the frequency of the parasitic resonance does not fall within the operating frequency band of an antenna including at least one antenna radiator.

According to various embodiments, the ground plane 810 (e.g., electromagnetic shielding layer) of the first display module 3 may include a first partial ground plane 811 positioned in the first display area 31, a second partial ground plane 812 positioned in the second display area 32, and a third partial ground plane 813 positioned in the third display area 33. The ground plane 810 of the first display module 3 may include a fourth partial ground plane 814 positioned in the first bendable display area 34. The ground plane 810 of the first display module 3 may include a fifth partial ground plane 815 positioned in the second bendable display area 35.

According to various embodiments, in the folded state of the multi-foldable electronic device 2, the second housing 22 is positioned between the first housing 21 and the third housing 23, so that the first partial ground plane 811 of the first display area 31 may be spaced apart from the second ground structure 820 positioned in the second housing 22 by a first distance 801 (see FIGS. 8A, 8B, and 9) in a direction (e.g., a direction parallel to the Z-axis) orthogonal to the first back cover B1 or the third back cover B3, and the third partial ground plane 813 of the third display area 33 may be spaced apart from the second ground structure 820 by a second distance 802 (see FIGS. 8A, 8B, and 9) greater than the first distance 801. In FIGS. 8A, 8B, and 9, a first straight line having double-sided arrows indicating the first distance 801 is illustrated to be longer than a second straight line having double-sided arrows indicating the second distance 802; however, it should be noted that this does not indicate that the first distance 801 is greater than the second distance 802.

According to various embodiments, in the folded state of the multi-foldable device 2, the third partial ground plane 813 and the second ground structure 820 may form a waveguide structure. In the folded state of the multi-foldable device 2, the waveguide structure including the third partial ground plane 813 and the second ground structure 820 may cause parasitic resonance due to an electromagnetic influence (e.g., electromagnetic coupling) from energy (also referred to as electromagnetic wave energy) radiated from at least one antenna radiator (e.g., the first partial metal portion 211 and/or the second partial metal portion 212). The waveguide structure including the third partial ground plane 813 and the second ground structure 820 may have a capacitance of a third value C3 (see FIG. 8B) due to the second distance 802 between the third partial ground plane 813 and the second ground structure 820. The capacitance of the third value C3 due to the second distance 802 may adjust the frequency of parasitic resonance formed by the waveguide structure including the third partial ground plane 813 and the second ground structure 820 so that the frequency of the parasitic resonance does not fall within the operating frequency band of an antenna including at least one antenna radiator. Configuring the frequency of parasitic resonance formed by the waveguide structure so as not to fall within the operating frequency band of an antenna including at least one antenna radiator may reduce power leakage, thereby reducing degradation of antenna radiation performance for at least one antenna radiator. The antenna is configured to allow the wireless communication circuit to transmit and/or receive an electromagnetic signal through at least one antenna radiator, and may include at least one antenna radiator and an antenna ground. It may be understood that configuring the frequency of parasitic resonance formed by the waveguide structure so as not to fall within the operating frequency band of an antenna including at least one antenna radiator may reduce degradation of antenna radiation performance for at least one antenna radiator even when a capacitance value between the third partial ground plane 813 and the second ground structure 820 is not adjusted (e.g., maintained at a default value) in the folded state of the multi-foldable electronic device 2. Configuring the frequency of parasitic resonance formed by the waveguide structure so as not to fall within the operating frequency band of an antenna including at least one antenna radiator may be understood as configuring the third partial ground plane 813 and the second ground structure 820 to function effectively as an antenna ground for the at least one antenna radiator. Configuring the frequency of parasitic resonance formed by the waveguide structure so as not to fall within the operating frequency band of an antenna including at least one antenna radiator may be understood as the third partial ground plane 813 is electromagnetically well integrated with the second ground structure 820 as an antenna ground for the at least one antenna radiator. In order to enhance the ground connection between the third partial ground plane 813 positioned in the third housing 23 and the second ground structure 820 positioned in the second housing 22 in the folded state of the multi-foldable electronic device 2, in a situation where it is structurally difficult to implement an additional electrical path (e.g., grounding path) that electrically connects the third partial ground plane 813 and the second ground structure 820 without crossing the second hinge part H2 (see FIG. 2C), it may be understood that the second distance 802 between the third partial ground plane 813 and the second ground structure 820 is formed such that the frequency of parasitic resonance formed by the waveguide structure does not fall within the resonant frequency band of an antenna including at least one antenna radiator.

According to various embodiments, in a folded state of a foldable electronic device 900 (see FIG. 9) of the comparative example, the first partial ground plane 811 and the second ground structure 820 may form a waveguide structure. In the folded state of the multi-foldable device 900 of the comparative example, the waveguide structure including the first partial ground plane 811 and the second ground structure 820 may cause parasitic resonance due to an electromagnetic influence (e.g., electromagnetic coupling) from energy (also referred to as electromagnetic wave energy) radiated from at least one antenna radiator (e.g., the first partial metal portion 211 and/or the second partial metal portion 212). At least one antenna radiator that may electrically affect the waveguide structure is not limited to the first partial metal portion 211 and/or the second partial metal portion 212 and may vary. The waveguide structure including a first partial ground plane 811 and a second ground structure 820 may have a capacitance of a fourth value C4 (see FIG. 9) due to the first distance 801 between the first partial ground plane 811 and the second ground structure 820. By the capacitance of the fourth value C4 due to the first distance 801, the frequency of parasitic resonance formed by the waveguide structure including the first partial ground plane 811 and the second ground structure 820 may fall within the resonant frequency band of an antenna including at least one antenna radiator. It may be understood that the frequency of parasitic resonance formed by the waveguide structure falling within the resonant frequency band of an antenna including at least one antenna radiator may cause degradation in antenna radiation performance due to power leakage. The frequency of parasitic resonance formed by the waveguide structure falling within the resonant frequency band of an antenna including at least one antenna radiator may cause degradation in antenna radiation performance for the at least one antenna radiator due to power leakage. The frequency of parasitic resonance formed by the waveguide structure falling within the resonant frequency band of an antenna including at least one antenna radiator may be understood as a situation in which it is necessary to adjust a capacitance value between the first partial ground plane 811 and the second ground structure 820 in order to reduce degradation in the antenna radiation performance for the at least one antenna radiator in the folded state of the multi-foldable electronic device 2. The frequency of parasitic resonance formed by the waveguide structure falling within the resonant frequency band of an antenna including at least one antenna radiator may be understood as a condition in which the first partial ground plane 811 and the second ground structure 820 do not effectively function as an antenna ground for the at least one antenna radiator. The frequency of parasitic resonance formed by the waveguide structure falling within the resonant frequency band of an antenna including at least one antenna radiator may be understood as a condition in which the first partial ground plane 811 is not electromagnetically well integrated with the second ground structure 820 as an antenna ground for at least one antenna radiator.

According to various embodiments, the first distance 801 may be, but is not limited to, about 2.0 mm (millimeter) to about 5.0 mm.

According to various embodiments, the multi-foldable electronic device 2 may include a metal layer 6 configured to enhance the ground connection between the first partial ground plane 811 and the second ground structure 820 in the folded state. For example, the metal layer 6 may be positioned in the second housing 22. In a direction orthogonal to the second back cover B2 (e.g., in the z-axis direction), the metal layer 6 and the second ground structure 820 may be at least partially spaced apart. In various embodiments, in the folded state of the multi-foldable electronic device 2, the metal layer 6 may be positioned between the first partial ground plane 811 and the second ground structure 820. The metal layer 6 may be electrically connected to the second ground structure 820. The multi-foldable electronic device 2 may include, for example, a first electrical member 71 and/or a second electrical member 72 configured to electrically connect the metal layer 6 and the second ground structure 820.

According to various embodiments, the metal layer 6 may be positioned between the second back cover B2 and the second frame F2 (e.g., the second bracket F21 of the second frame F2). The metal layer 6 may be disposed on or coupled (e.g., attached) to the second back cover B2 between the second back cover B2 and the second bracket F21. The metal layer 6 may be coupled to the second back cover B2 via an adhesive material (or bonding material) disposed between the metal layer 6 and the second back cover B2. At least one second PCB 512 may be positioned at least partially between the metal layer 6 and the second bracket F21. The metal layer 6 may be positioned at least partially between the second back cover B2 and the at least one second PCB 512. The metal layer 6 may be positioned at least partially between the second back cover B2 and the second battery 521. In the folded state of the multi-foldable electronic device 2, when viewed from above the first back cover B1, the first display area 31 of the first display module 3 and the metal layer 6 may overlap.

According to various embodiments, the metal layer 6 may be a metal sheet disposed on the second back cover B2. The metal sheet may be made of various metal materials having electrical conductivity.

According to various embodiments, the metal layer 6 may be electrically connected to a second ground area of at least one second PCB 512 disposed on the second bracket F21. The metal layer 6 may be, for example, electrically connected to at least one second PCB 512 via the first electrical connection member 71 and/or the second electrical connection member 72.

According to various embodiments, the first electrical connection member 71 may include a first conductive clip (e.g., a first conductive structure including a resilient structure). The second electrical connection member 72 may include a second conductive clip (e.g., a second conductive structure including a resilient structure). For example, the first conductive clip and/or the second conductive clip may be disposed (e.g., surface-mounted) on at least one second PCB 512 between the metal layer 6 and the at least one second PCB 512. The first conductive clip and/or the second conductive clip may be in resilient contact with the metal layer 6 between the metal layer 6 and the at least one second PCB 512. The first electrical connecting member 71 and/or the second electrical connecting member 72 are not limited to conductive clips and may take various forms, such as other types of flexible conductive members, including pogo-pins, springs, conductive poron, conductive sponge, or conductive rubber, conductive adhesive members (e.g., conductive tape), or conductive connectors.

According to various embodiments, at least one second PCB 512 may include a first conductive pad (not separately illustrated) configured to be physically and electrically connected to the first electrical connection member 71. At least one second PCB 512 may include a first conductive line configured to electrically connect the first conductive pad and a second ground area of the at least one second PCB 512. The first electrical connecting member 71, the first conductive pad, and the first conductive line may be understood as a first grounding path GP1 (see FIG. 8A) configured to electrically connect a first point P1 (e.g., a shorting point or a ground point) on the metal layer 6 and a second ground structure 820 (see FIGS. 8A and 8B) (e.g., a second ground area of at least one second PCB 512). In various embodiments, the first conductive pad and the first conductive line may be omitted, and the first electrical connecting member 71 may be physically and electrically coupled to the second ground area of at least one second PCB 512, and the first grounding path GP1 may be understood as the first electrical connecting member 71. The first grounding path GP1 may enhance the ground connection between the metal layer 6 and the second ground structure 820. The first grounding path GP1 and the metal layer 6 may enhance the ground connection between the first partial ground plane 811 and the second ground structure 820 in the folded state of the multi-foldable electronic device 2.

According to various embodiments, at least one second PCB 512 may include a second conductive pad (not separately illustrated) configured to be physically and electrically connected to the second electrical connection member 72. The at least one second PCB 512 may include a second conductive line configured to electrically connect the second conductive pad and a second ground area of the at least one second PCB 512. The second electrical connection member 72, the second conductive pad, and the second conductive line may be understood as a second grounding path GP2 (see FIG. 8A) configured to electrically connect a second point P2 (e.g., a shorting point or a ground point) on the metal layer 6 and the second ground structure 820 (see FIGS. 8A and 8B) (e.g., a second ground area of the at least one second PCB 512). In various embodiments, the second conductive pad and the second conductive line may be omitted, the second electrical connection member 72 may be physically and electrically coupled to the second ground area of at least one second PCB 512, and the second grounding path GP2 may be understood as the second electrical connection member 72. The second grounding path GP2 may enhance the ground connection between the metal layer 6 and the second ground structure 820. The second grounding path GP2 and the metal layer 6 may at least enhance the ground connection between the first partial ground plane 811 and the second ground structure 820 in the folded state of the multi-foldable electronic device 2.

According to various embodiments, the first partial metal portion 211 configured to operate as an antenna radiator may be understood as at least one first antenna radiator (also referred to as an upper antenna radiator). The second partial metal portion 212 configured to operate as an antenna radiator may be understood as at least one second antenna radiator (also referred to as a lower antenna radiator). For example, in order to reduce parasitic resonance generated by a waveguide structure (e.g., the first partial ground plane 811 and the second ground structure 820) formed in the folded state of the multi-foldable electronic device 2 from degrading antenna radiation performance of the first antenna including at least one first antenna radiator, the first point P1 on the metal layer 6 may be positioned closer to the at least one first antenna radiator than the second point P2 on the metal layer 6. The first antenna is configured to allow the wireless communication circuit to transmit and/or receive an electromagnetic signal via at least one first antenna radiator, and may include at least one first antenna radiator and an antenna ground. In order to reduce parasitic resonance generated by a waveguide structure (e.g., the first partial ground plane 811 and the second ground structure 820) formed in the folded state of the multi-foldable electronic device 2 from degrading antenna radiation performance of the second antenna including at least one second antenna radiator, the second point P2 on the metal layer 6 may be positioned closer to the at least one second antenna radiator than the first point P1 on the metal layer 6. The second antenna is configured to allow the wireless communication circuit to transmit and/or receive an electromagnetic signal via at least one second antenna radiator, and may include at least one second antenna radiator and an antenna ground. In various embodiments, the first antenna and the second antenna may be configured to transmit and/or receive electromagnetic signals in substantially the same frequency band. In various embodiments, the first antenna and the second antenna may be configured to transmit and/or receive electromagnetic signals in at least some different frequency bands.

According to various embodiments, in order to electrically connect the metal layer 6 to the second ground structure 820, the first electrical connection member 71 and/or the second electrical connection member 72 may be physically and electrically coupled to a second inner metal portion included in the second bracket F21 of the second frame F2 and be in electrical contact with the metal layer 6.

According to various embodiments, the first electrical connection member 71 and/or the second electrical connection member 72 may be physically and electrically coupled to the metal layer 6.

According to various embodiments, the first grounding path GP1 and/or the second grounding path GP2 may be implemented as various conductive portions or conductive structures between the metal layer 6 and the second ground structure 820. The number or position of grounding paths between the metal layer 6 and the second ground structure 820 is not limited to the illustrated example.

According to various embodiments, in the folded state of the multi-foldable device 2, the first partial ground plane 811, the metal layer 6, and the second ground structure 820 may form a waveguide structure. The waveguide structure may have a capacitance of a first value C1 (see FIG. 8B) between the first partial ground plane 811 and the metal layer 6. The waveguide structure may have a capacitance of a second value C2 (see FIG. 8B) between the metal layer 6 and the second ground structure 820. The waveguide structure including the first partial ground plane 811, the metal layer 6, and the second ground structure 820 may cause parasitic resonance due to an electromagnetic influence (e.g., electromagnetic coupling) from energy (also referred to as electromagnetic wave energy) radiated from at least one antenna radiator (e.g., the first partial metal portion 211 and/or the second partial metal portion 212). The waveguide structure including the first partial ground plane 811, the metal layer 6, and the second ground structure 820 may have a capacitance of a first value C1 (see FIG. 8B) between the first partial ground plane 811 and the metal layer 6, and a capacitance of a second value C2 (see FIG. 8B) between the metal layer 6 and the second ground structure 820. The waveguide structure including the first partial ground plane 811, the metal layer 6, and the second ground structure 820 may be understood as a series circuit including a capacitance of the first value C1 and a capacitance of the second value C2. In the series circuit, a total capacitance determined from capacitance values of the first value C1 and the second value C2 may be used to adjust the frequency of parasitic resonance formed by the waveguide structure including the first partial ground plane 811, the metal layer 6, and the second ground structure 820 so that the frequency of the parasitic resonance does not fall within the operating frequency band of an antenna including at least one antenna radiator. Configuring the frequency of parasitic resonance formed by the waveguide structure so as not to fall within the operating frequency band of an antenna including at least one antenna radiator may reduce power leakage, thereby reducing degradation in antenna radiation performance for the at least one antenna radiator. It may be understood that configuring the frequency of parasitic resonance formed by the waveguide structure so as not to fall within the operating frequency band of an antenna including at least one antenna radiator is intended to ensure that the first partial ground plane 811 and the second ground structure 820 may function effectively as an antenna ground for the at least one antenna radiator through the metal layer 6 configured to enhance the ground connection between the first partial ground plane 811 and the second ground structure 820 in the folded state of the multi-foldable electronic device 2. It may be understood that configuring the frequency of parasitic resonance formed by the waveguide structure so as not to fall within the operating frequency band of an antenna including at least one antenna radiator is intended to ensure that the first partial ground plane 811 is electromagnetically integrated well with the second ground structure 820 as an antenna ground for the at least one antenna radiator through the metal layer 6 configured to enhance the ground connection between the first partial ground plane 811 and the second ground structure 820 in the folded state of the multi-foldable electronic device 2. In a situation where there is a structural constraint that makes it difficult to implement an additional electrical path (e.g., grounding path) to electrically connect between the first partial ground plane 811 and the second ground structure 820 without crossing the first hinge part H1 (see FIG. 2C) and the second hinge part H2 (see FIG. 2C), the metal layer 6 may enhance the ground connection between the first partial ground plane 811 and the second ground structure 820 as part of the antenna ground for at least one antenna radiator in the folded state of the multi-foldable electronic device 2. The metal layer 6 configured to enhance the ground connection between the first partial ground plane 811 and the second ground structure 820 may reduce or prevent the influence of an electrical path (e.g., a length expressed as a ratio of the wavelength) of the first partial ground plane 811 on frequency characteristics of an antenna including at least one antenna radiator in the folded state of the multi-foldable electronic device 2.

According to various embodiments, it may be understood that the metal layer 6 is configured to adjust frequency characteristics (e.g., resonant frequency) of at least one antenna radiator (e.g., the first partial metal portion 211 and/or the second partial metal portion 212 of FIG. 7).

According to various embodiments, the multi-foldable electronic device 2 may include at least one matching circuit (e.g., a first matching circuit M1 and/or a second matching circuit M2 of FIG. 8A). The at least one matching circuit may be disposed (e.g., surface-mounted) on at least one second PCB 512. The at least one matching circuit may include, for example, an electrical element having a component such as inductance, capacitance, or conductance. The at least one matching circuit may include, for example, various elements such as a lumped element or a passive element. At least one matching circuit may include a switching circuit (e.g., switching element) configured to adjust an element value (e.g., an inductance value, a capacitance value, or a conductance value) in response to a signal from the processor (e.g., the processor 120 of FIG. 1) included in the multi-foldable electronic device 2 or a circuit such as the wireless communication circuit 51. The at least one matching circuit may shift a resonant frequency of at least one antenna radiator (e.g., the first partial metal portion 211 and/or the second partial metal portion 212) to a designated frequency or shift it by a designated amount. The at least one matching circuit may perform impedance matching for at least one antenna. The at least one matching circuit may be configured to substantially match an impedance of an electrical path (e.g., a transmission line or a feed line) that electrically connects the wireless communication circuit and at least one antenna radiator and an impedance of the at least one antenna radiator. Impedance matching may reduce degradation of antenna radiation performance by reducing an amount of reflection at a connection portion between the transmission line and at least one antenna radiator.

According to various embodiments, the first matching circuit M1 (see FIG. 8A) may be electrically connected to a first grounding path GP1 configured to electrically connect a first point P1 of the metal layer 6 and the second ground structure 820 (see FIGS. 8A and 8B) (e.g., the second ground area of at least one second PCB 512). For example, the at least one second PCB 512 may include a first conductive pad (not separately illustrated) configured to be physically and electrically connected to the first electrical connection member 71, and a first conductive line configured to electrically connect the first conductive pad and the second ground area of the at least one second PCB 512. The first matching circuit M1 may be disposed on the first conductive line of the at least one second PCB 512.

According to various embodiments, in order to reduce parasitic resonance generated by the waveguide structure (e.g., the first partial ground plane 811 and the second ground structure 820) formed in the folded state of the multi-foldable electronic device 2 from degrading antenna radiation performance of the first antenna including at least one first antenna radiator (e.g., the first partial metal portion 211), the first matching circuit M1 disposed in the first grounding path GP1 may be configured to adjust the frequency of the parasitic resonance so as not to fall within the operating frequency band of the first antenna.

According to various embodiments, the second matching circuit M2 (see FIG. 8A) may be electrically connected to the second grounding path GP2 configured to electrically connect the second point P2 of the metal layer 6 and the second ground structure 820 (see FIGS. 8A and 8B) (e.g., the second ground area of at least one second PCB 512). For example, the at least one second PCB 512 may include a second conductive pad (not separately illustrated) configured to be physically and electrically connected to the second electrical connection member 72, and a second conductive line configured to electrically connect the second conductive pad and the second ground area of the at least one second PCB 512. The second matching circuit M2 may be disposed on the second conductive line of the at least one second PCB 512.

According to various embodiments, in order to reduce parasitic resonance generated by the waveguide structure (e.g., the first partial ground plane 811 and the second ground structure 820) formed in the folded state of the multi-foldable electronic device 2 from degrading antenna radiation performance of the second antenna including at least one second antenna radiator (e.g., the second partial metal portion 212), the second matching circuit M2 disposed in the second grounding path GP2 may be configured to adjust the frequency of the parasitic resonance so as not to fall within the operating frequency band of the second antenna.

According to various embodiments, at least one matching circuit may be electrically connected to a transmission line (also referred to as a feed line) that electrically connects the wireless communication circuit and at least one antenna radiator (e.g., the first partial metal portion 211 and/or the second partial metal portion 212). The at least one matching circuit may be disposed in the transmission line.

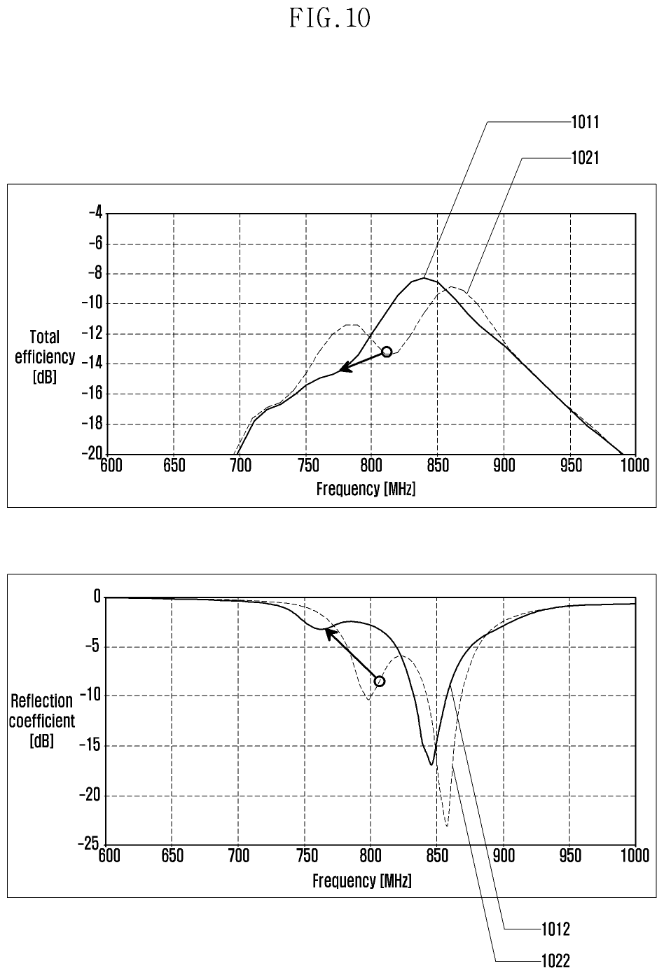

FIG. 10 is a graph illustrating antenna radiation performance in a folded state of a multi-foldable electronic device 2 (see FIG. 8A) of the disclosure and a multi-foldable electronic device 900 (see FIG. 9) of a comparative example according to various embodiments.

With reference to FIGS. 8A, 8B, 9, and 10, 1011 represents total efficiency (e.g., gain characteristic reflecting input impedance matching characteristic) for a multi-foldable electronic device 2 according to various embodiments of the disclosure. 1021 represents total efficiency for the multi-foldable electronic device 900 of the comparative example. 1012 represents a reflection coefficient for a multi-foldable electronic device 2 according to various embodiments of the disclosure. 1022 represents a reflection coefficient for the multi-foldable electronic device 900 of the comparative example. The multi-foldable electronic device 2 of the disclosure may shift the frequency of parasitic resonance formed through the first partial ground plane 811 and the second ground structure 820 through the metal layer 6 configured to enhance ground connection between the first partial ground plane 811 and the second ground structure 820 in the folded state so that the frequency of the parasitic resonance does not fall within an operating frequency band (e.g., about 800 MHz to about 830 MHz) of an antenna including at least one antenna radiator.

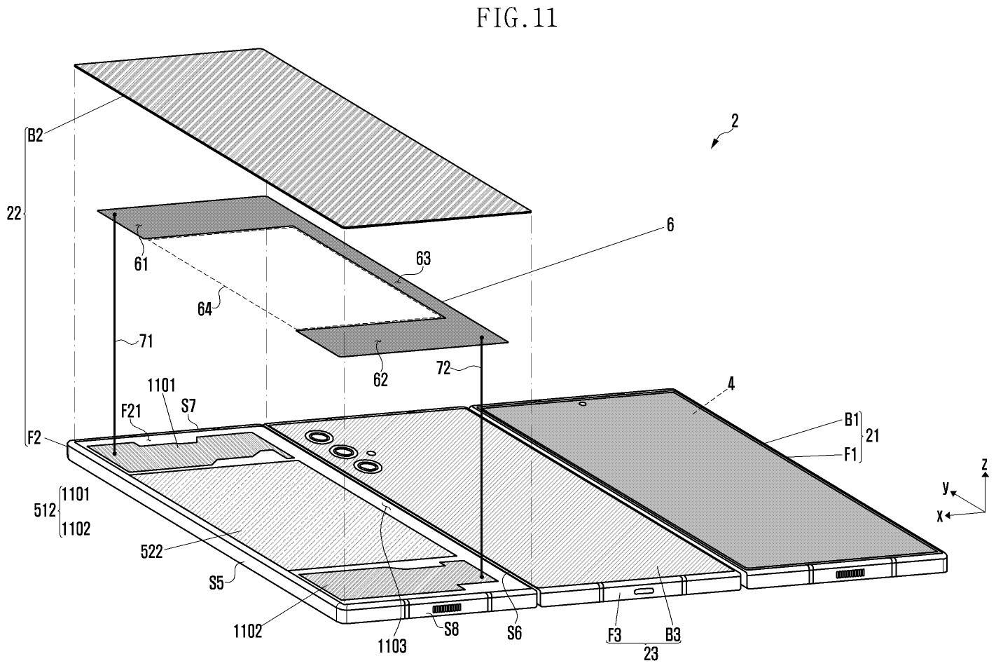

FIG. 11 is a partial exploded perspective view illustrating a multi-foldable electronic device 2 in an unfolded state according to various embodiments.

It should be understood that various combinations of features and/or embodiments disclosed in connection with FIG. 11 are contemplated and encompassed by the disclosure. Various combinations of features described below in connection with FIG. 11 may be considered to be included in the disclosure as specific examples.

With reference to FIG. 11, the multi-foldable electronic device 2 may include a first housing 21, a second housing 22, and a third housing 23. The first housing 21 may include a first frame F1 and a first back cover B1. The first frame F1 may include a first bracket F11 and a first side member F12. The second housing 22 may include a second frame F2 and a second back cover B2. The second frame F2 may include a second bracket F21 and a second side member F22. The third housing 23 may include a third frame F3 and a third back cover B3. The third frame F3 may include a third bracket F31 and a third side member F32. The multi-foldable electronic device 2 may include a first display module 3. For example, the multi-foldable electronic device 2 may include a second display module 4. The multi-foldable electronic device 2 may include at least one second PCB 512. The multi-foldable electronic device 2 may include a second battery 522. The multi-foldable electronic device 2 may include a metal layer 6. The multi-foldable electronic device 2 may include a first electrical connection member 71 and/or a second electrical connection member 72. Descriptions of some components that are the same as in the previous embodiment may not be repeated.

According to various embodiments, at least one second PCB 512 may include an upper PCB 1101 and a lower PCB 1102. When viewed from above the second back cover B2, the second battery 522 may be positioned between the upper PCB 1101 and the lower PCB 1102. When viewed from above the second back cover B2, the upper PCB 1101 may be positioned closer to the seventh side S7 of the second frame F2 than the second battery 522, and be positioned between the seventh side S7 and the second battery 522. The lower PCB 1102 may be positioned closer to the eighth side S8 of the second frame F2 than the second battery 522, and be positioned between the eighth side S8 and the second battery 522.

According to various embodiments, when viewed from above the second back cover B2, the metal layer 6 may overlap with the upper PCB 1101 and/or the lower PCB 1102. When viewed from above the second back cover B2, the metal layer 6 may not overlap with the second battery 522.

According to various embodiments, when viewed from above the second back cover B2, the metal layer 6 may include a first portion 61 overlapped with the upper PCB 1101, a second portion 62 overlapped with the lower PCB 1102, and a third portion 63 extended from the first portion 61 and the second portion 62. When viewed from above the second back cover B2, the second battery 522 may be positioned between the first portion 61 of the metal layer 6 and the sixth side S6 of the second frame F2. When viewed from above the second back cover B2, the third portion 63 of the metal layer 6 may be positioned at least partially between the second battery 522 and the sixth side S6 of the second frame F2. In various embodiments, when viewed from above the second back cover B2, a portion of the third portion 63 of the metal layer 6 may overlap with at least one second PCB 512. The metal layer 6 may include an opening 64 formed by the first portion 61, the second portion 62, and the third portion 63, when viewed from above the second back cover B2. The opening 64 may overlap with the second battery 522, when viewed from above the second back cover B2. The opening 64 of the metal layer 6 may allow the second housing 22 to be slim while enabling the size of the second battery 522 to be expanded in a direction orthogonal to the second back cover B2.

According to various embodiments, when viewed from above the second back cover B2, the third portion 63 of the metal layer 6 may overlap with the hinge area 1103 of the second housing 22. The second bracket F21 included in the second frame F2 of the second housing 22 may include a hinge area 1103 coupled with the second hinge part H2 (see FIG. 2C) that rotatably connects the second housing 22 and the third housing 23.

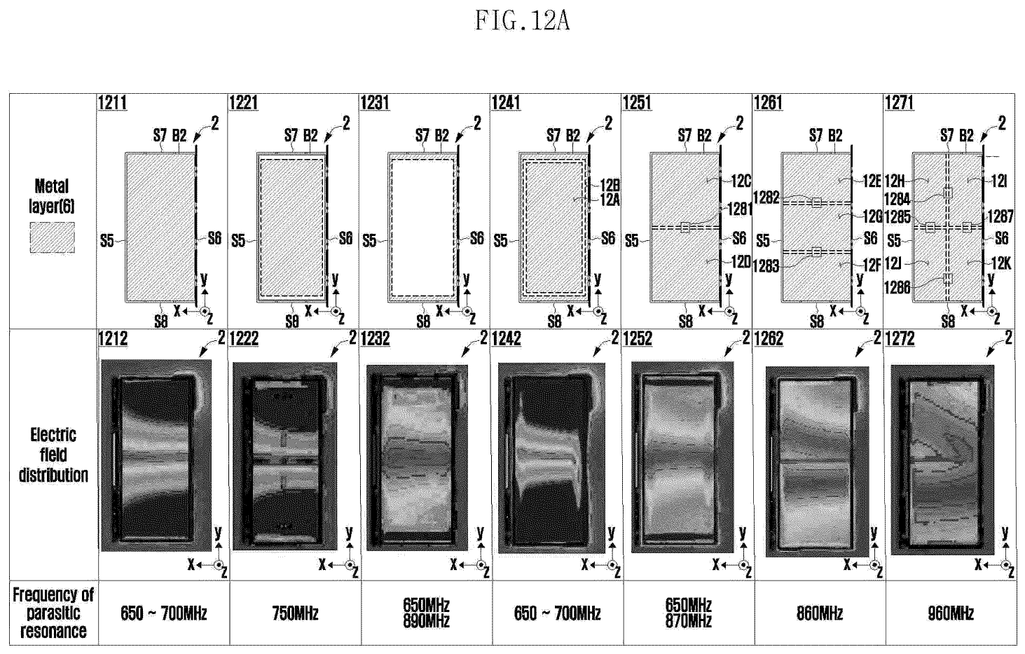

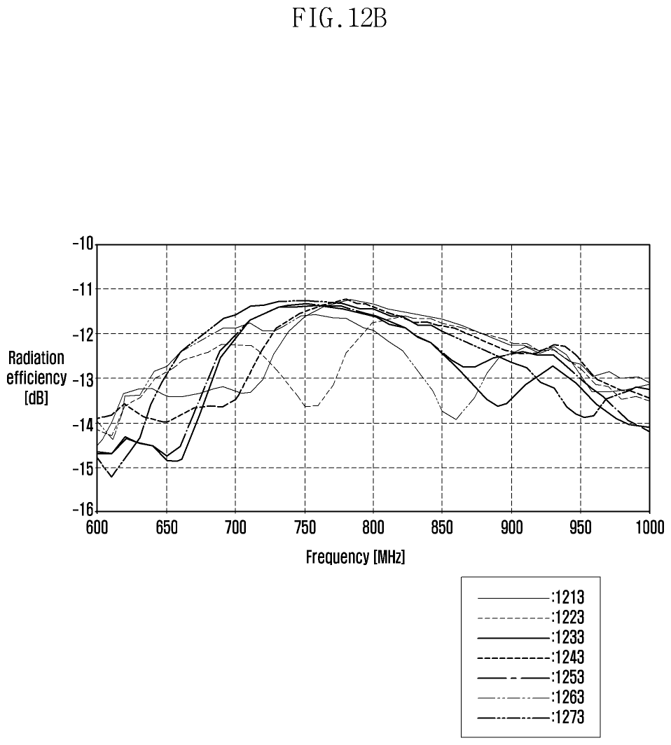

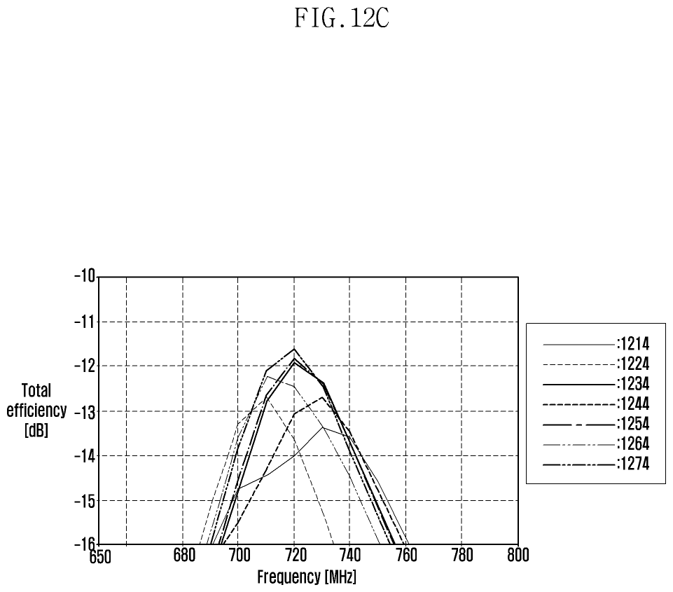

FIG. 12A is a diagram illustrating an example shape of a metal layer 6 in a multi-foldable electronic device 2 according to various embodiments, and illustrating heat maps of an electric field distribution and a frequency of parasitic resonance according to the shape of the metal layer 6 according to various embodiments.

FIG. 12B is a graph illustrating radiation efficiency in a folded state of a multi-foldable electronic device 2 according to a shape of the metal layer 6 according to various embodiments.

FIG. 12C is a graph illustrating total efficiency in a folded state of a multi-foldable electronic device 2 according to a shape of the metal layer 6 according to various embodiments.

It should be understood that various combinations of features and/or embodiments disclosed in connection with FIGS. 12A, 12B, and 12C are contemplated and encompassed by the disclosure. Various combinations of features described below in connection with FIGS. 12A, 12B, and 12C may be considered to be included in the disclosure as specific examples.

With reference to FIGS. 12A, 12B, and 12C, when an electromagnetic signal (or a radio signal, an RF signal, or a radiating current) is provided (or fed) to at least one antenna radiator (e.g., the first partial metal portion 211 and/or the second partial metal portion 212 of FIG. 7), antenna radiation performance for a designated or selected frequency band (operating frequency band or usage frequency band) may be affected by frequency characteristics (e.g., resonant frequency) of parasitic resonance that varies according to the shape of the metal layer 6.

According to various embodiments, 1211 is a diagram illustrating a portion of a multi-foldable electronic device 2 in an unfolded state according to a first example. 1212 is a heat map illustrating an electric field distribution for the multi-foldable electronic device 2 in a folded state according to the first example. 1213 represents radiation efficiency (an antenna characteristic substantially unrelated to an input impedance characteristic of the antenna) of the multi-foldable electronic device 2 in a folded state according to the first example. 1214 represents total efficiency (e.g., gain characteristic reflecting an input impedance matching characteristic) for the multi-foldable electronic device 2 in a folded state according to the first example. According to the first example, when viewed from above the second back cover B2, the metal layer 6 may be implemented to substantially overlap an entire area of the second back cover B2. When viewed from above the second back cover B2, the metal layer 6 may be rectangular. When an electromagnetic signal (or a radio signal, an RF signal, or a radiating current) is provided (or fed) to at least one antenna radiator (e.g., the first partial metal portion 211 and/or the second partial metal portion 212 of FIG. 7), parasitic resonance having a frequency of about 650 MHz to about 700 MHz may be generated in the multi-foldable electronic device 2 in the folded state.

According to various embodiments, 1221 is a diagram illustrating a portion of a multi-foldable electronic device 2 in an unfolded state according to a second example. 1222 is a heat map illustrating an electric field distribution for the multi-foldable electronic device 2 in a folded state according to the second example. 1223 represents radiation efficiency for the multi-foldable electronic device 2 in a folded state according to the second example. 1224 represents total efficiency for the multi-foldable electronic device 2 in a folded state according to the second example. According to the second example, when viewed from above the second back cover B2, the metal layer 6 may overlap the second back cover B2 and be a rectangle including edges spaced from the fifth side S5, the sixth side S6, the seventh side S7, and the eighth side S8. For example, the metal layer 6 may be formed to have a smaller size than that of the second back cover B2. A shape of the metal layer 6 is not limited to a rectangle. When an electromagnetic signal (or a radio signal, an RF signal, or a radiating current) is provided (or fed) to at least one antenna radiator (e.g., the first partial metal portion 211 and/or the second partial metal portion 212 of FIG. 7), parasitic resonance having a frequency of about 750 MHz may be generated in the multi-foldable electronic device 2 in the folded state.

According to various embodiments, 1231 is a diagram illustrating a portion of a multi-foldable electronic device 2 in an unfolded state according to a third example. 1232 is a heat map illustrating an electric field distribution for the multi-foldable electronic device 2 in a folded state according to the third example. 1233 represents radiation efficiency for the multi-foldable electronic device 2 in a folded state according to the third example. 1234 represents total efficiency for the multi-foldable electronic device 2 in a folded state according to the third example. According to the third example, when viewed from above the second back cover B2, the metal layer 6 may overlap the second back cover B2 and have a rectangular annular shape. For example, the metal layer 6 may include a through hole. A shape of the metal layer 6 is not limited to a rectangular annular shape. When an electromagnetic signal (or a radio signal, an RF signal, or a radiating current) is provided (or fed) to at least one antenna radiator (e.g., the first partial metal portion 211 and/or the second partial metal portion 212 of FIG. 7), parasitic resonance having a frequency of about 650 MHz and about 890 MHz may be generated in the multi-foldable electronic device 2 in the folded state.

According to various embodiments, 1241 is a diagram illustrating a portion of a multi-foldable electronic device 2 in an unfolded state according to a fourth example. 1242 is a heat map illustrating an electric field distribution for the multi-foldable electronic device 2 in a folded state according to the fourth example. 1243 represents radiation efficiency for the multi-foldable electronic device 2 in a folded state according to the fourth example. 1244 represents total efficiency for the multi-foldable electronic device 2 in a folded state according to the fourth example. According to the fourth example, when viewed from above the second back cover B2, the metal layer 6 may overlap the second back cover B2 and include two partial metal layers 12A and 12B separated from each other. When viewed from above the second back cover B2, one partial metal layer 12A may be surrounded by the remaining partial metal layer 12B. For example, when viewed from above the second back cover B2, one partial metal layer 12A may have a rectangular shape and the remaining partial metal layer 12B may have a rectangular annular shape. Shapes of the two partial metal layers 12A and 12B are not limited to the illustrated example. When an electromagnetic signal (or a radio signal, an RF signal, or a radiating current) is provided (or fed) to at least one antenna radiator (e.g., the first partial metal portion 211 and/or the second partial metal portion 212 of FIG. 7), parasitic resonance having a frequency of about 650 MHz to about 700 MHz may be generated in the multi-foldable electronic device 2 in the folded state.

According to various embodiments, 1251 is a diagram illustrating a portion of a multi-foldable electronic device 2 in an unfolded state according to a fifth example. 1252 is a heat map illustrating an electric field distribution for the multi-foldable electronic device 2 in a folded state according to the fifth example. 1253 represents radiation efficiency for the multi-foldable electronic device 2 in a folded state according to the fifth example. 1254 represents total efficiency for the multi-foldable electronic device 2 in a folded state according to the fifth example. According to the fifth example, when viewed from above the second back cover B2, the metal layer 6 may overlap the second back cover B2 and include two partial metal layers 12C and 12D separated from each other. When viewed from above the second back cover B2, one partial metal layer 12A may be positioned close to the third side S3, and the remaining partial metal layer 12B may be positioned close to the fourth side S4. The two partial metal layers 12C and 12D may be rectangular, but are not limited thereto. When an electromagnetic signal (or a radio signal, an RF signal, or a radiating current) is provided (or fed) to at least one antenna radiator (e.g., the first partial metal portion 211 and/or the second partial metal portion 212 of FIG. 7), parasitic resonance having a frequency of about 650 MHz and about 870 MHz may be generated in the multi-foldable electronic device 2 in the folded state.

According to various embodiments, 1261 is a diagram illustrating a portion of a multi-foldable electronic device 2 in an unfolded state according to a sixth example. 1262 is a heat map illustrating an electric field distribution for a multi-foldable electronic device 2 in a folded state according to the sixth example. 1263 represents radiation efficiency for a multi-foldable electronic device 2 in a folded state according to the sixth example. 1264 represents total efficiency for a multi-foldable electronic device 2 in a folded state according to the sixth example. According to the sixth example, when viewed from above the second back cover B2, the metal layer 6 may overlap the second back cover B2 and include three partial metal layers 12E, 12F, and 12G separated from each other. When viewed from above the second back cover B2, one partial metal layer 12E may be positioned close to the third side S3, another partial metal layer 12F may be positioned close to the fourth side S4, and the remaining partial metal layer 12G may be positioned between the two partial metal layers 12E and 12F. The three partial metal layers 12E, 12F, and 12G may be rectangular, but are not limited thereto. When an electromagnetic signal (or a wireless signal, an RF signal, or a radiating current) is provided (or fed) to at least one antenna radiator (e.g., the first partial metal portion 211 and/or the second partial metal portion 212 of FIG. 7), parasitic resonance having a frequency of about 860 MHz may be generated in the multi-foldable electronic device 2 in the folded state.

According to various embodiments, 1271 is a diagram illustrating a portion of a multi-foldable electronic device 2 in an unfolded state according to a seventh example. 1272 is a heat map illustrating an electric field distribution for a multi-foldable electronic device 2 in a folded state according to the seventh example. 1273 represents radiation efficiency for a multi-foldable electronic device 2 in a folded state according to the seventh example. 1274 represents total efficiency for a multi-foldable electronic device 2 in a folded state according to the seventh example. According to the seventh example, when viewed from above the second back cover B2, the metal layer 6 may overlap the second back cover B2 and include four partial metal layers 12H, 12I, 12J, and 12K separated from each other. When viewed from above the second back cover B2, the four partial metal layers 12H, 12I, 12K, and 12K may be disposed in a square lattice shape. The four partial metal layers 12H, 12I, 12K, and 12K may be rectangular, but are not limited thereto. When an electromagnetic signal (or a radio signal, an RF signal, or a radiating current) is provided (or fed) to at least one antenna radiator (e.g., the first partial metal portion 211 and/or the second partial metal portion 212 of FIG. 7), parasitic resonance having a frequency of about 960 MHz may be generated in the multi-foldable electronic device 2 in the folded state.

According to various embodiments, although not separately illustrated, a shape of the metal layer 6 and a frequency of parasitic resonance according to the shape of the metal layer 6 may vary.

According to various embodiments, in an example where the metal layer 6 is implemented as a plurality of separate partial metal layers (e.g., the fourth example of 1241, the fifth example of 1251, the sixth example of 1261, or the seventh example of 1271 in FIG. 12A), at least one of the plurality of partial metal layers may be electrically connected to the second ground structure 820 via at least one grounding path.

According to various embodiments, in an example where the metal layer 6 is implemented as a plurality of partial metal layers separated from each other (e.g., the fourth example of 1241, the fifth example of 1251, the sixth example of 1261, or the seventh example of 1271 in FIG. 12A), at least any two of the plurality of partial metal layers may be connected via at least one switch (e.g., a first switch 1281, a second switch 1282, a third switch 1283, a fourth switch 1284, a fifth switch 1285, a sixth switch 1286, or a seventh switch 1287). For example, any two partial metal layers may be electrically connected to at least one second PCB 512 of FIG. 6 via an electrical connection member such as a flexible conductive member, a conductive adhesive member, or a conductive connector, and at least one switch may be disposed (e.g., surface-mounted) on at least one second PCB 512 of FIG. 6 to electrically connect or disconnect the two partial metal layers in response to a control signal from the processor (e.g., the processor 120 of FIG. 1) or the wireless communication circuit (e.g., the wireless communication module 192 of FIG. 1). The multi-foldable electronic device 2 may be configured to electrically connect the two partial metal layers by turning on at least one switch between the two partial metal layers, or to electrically separate the two partial metal layers by turning off at least one switch between the two partial metal layers, so as to adjust parasitic resonance (e.g., frequency of parasitic resonance) in order to reduce degradation of antenna radiation performance. In various embodiments, at least one switch between at least any two of the plurality of partial metal layers may be understood as part of a matching circuit (e.g., the first matching circuit M1 or the second matching circuit M2 of FIG. 8A).

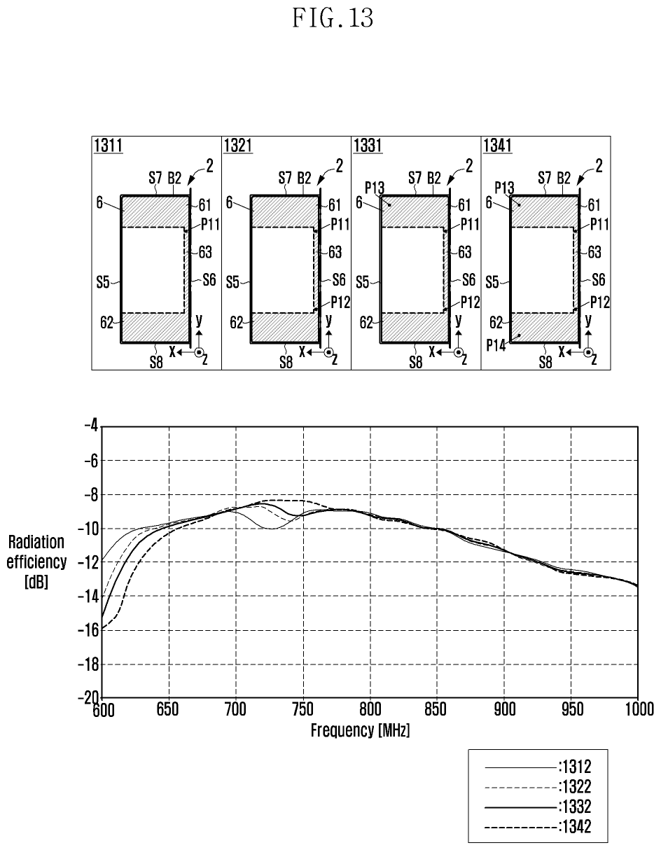

FIG. 13 is a diagram illustrating a shorting point on a metal layer 6 in a multi-foldable electronic device 2 according to various embodiments, and a graph illustrating radiation efficiency in a folded state of the multi-foldable electronic device 2 according to the shorting point according to various embodiments.

It should be understood that various combinations of features and/or embodiments disclosed in connection with FIG. 13 are contemplated and encompassed by the disclosure. Various combinations of features described below in connection with FIG. 13 may be considered to be included in the disclosure as specific examples.

With reference to FIG. 13, when an electromagnetic signal (or a radio signal, an RF signal, or a radiating current) is provided (or fed) to at least one antenna radiator (e.g., the first partial metal portion 211 and/or the second partial metal portion 212 of FIG. 7), antenna radiation performance for a designated or selected frequency band (operating frequency band or usage frequency band) may be affected by frequency characteristics (e.g., resonant frequency) of parasitic resonance that varies according to the number and/or position of shorting points on the metal layer 6.

According to various embodiments, the metal layer 6 may be a metal layer 6 according to the example of FIG. 11. For example, the metal layer 6 may include a first portion 61, a second portion 62, and a third portion 63.

According to various embodiments, 1311 is a diagram illustrating a portion of a multi-foldable electronic device 2 in an unfolded state according to an eighth example. 1312 illustrates radiation efficiency for the multi-foldable electronic device 2 in a folded state according to the eighth example. In the eighth example, the metal layer 6 may include a first shorting point P11 electrically connected to the second ground structure 820 (see FIGS. 8A and 8B). The first shorting point P11 may be positioned, for example, in the third portion 63 of the metal layer 6 and be positioned closer to the first portion 61 of the metal layer 6 than the second portion 62 of the metal layer 6.

According to various embodiments, 1321 is a diagram illustrating a portion of a multi-foldable electronic device 2 in an unfolded state according to a ninth example. 1322 illustrates radiation efficiency for a multi-foldable electronic device 2 in a folded state according to the ninth example. The ninth example may further include a second shorting point P12 on the metal layer 6 compared to the eighth example. The second shorting point P12 may be positioned, for example, in the third portion 63 of the metal layer 6 and be positioned closer to the second portion 62 of the metal layer 6 than the first portion 61 of the metal layer 6.

According to various embodiments, 1331 is a diagram illustrating a portion of a multi-foldable electronic device 2 in an unfolded state according to a tenth example. 1332 illustrates radiation efficiency for a multi-foldable electronic device 2 in a folded state according to the tenth example. The tenth example may further include a third shorting point P13 on the metal layer 6 compared to the ninth example. The third shorting point P13 may be positioned, for example, in the first portion 61 of the metal layer 6. In various embodiments, the third shorting point P13 may be positioned adjacent to the first partial metal portion 211 of FIG. 7 configured to operate as an antenna radiator, when viewed from above the first back cover B1 (see FIG. 3A) in the folded state of the multi-foldable electronic device 2.

According to various embodiments, 1341 is a diagram illustrating a portion of the multi-foldable electronic device 2 in an unfolded state according to an eleventh example. 1342 illustrates radiation efficiency for the multi-foldable electronic device 2 in a folded state according to the eleventh example. The eleventh example may further include a fourth shorting point P14 on the metal layer 6, compared to the tenth example. The fourth shorting point P14 may be positioned, for example, in the second portion 62 of the metal layer 6. In various embodiments, the fourth shorting point P14 may be positioned adjacent to the second partial metal portion 212 of FIG. 7 configured to operate as an antenna radiator, when viewed from above the first back cover B1 (see FIG. 3A) in the folded state of the multi-foldable electronic device 2.

According to various embodiments, with reference to 1311, 1321, 1331, and 1341, it is illustrated that radiation efficiency is improved in a designated or selected frequency band including about 730 MHz by adding shorting points on the metal layer 6. In various embodiments, radiation performance may be improved by removing or shifting parasitic resonance in a designated or selected frequency band using shorting points (e.g., according to the position and/or number of shorting points).

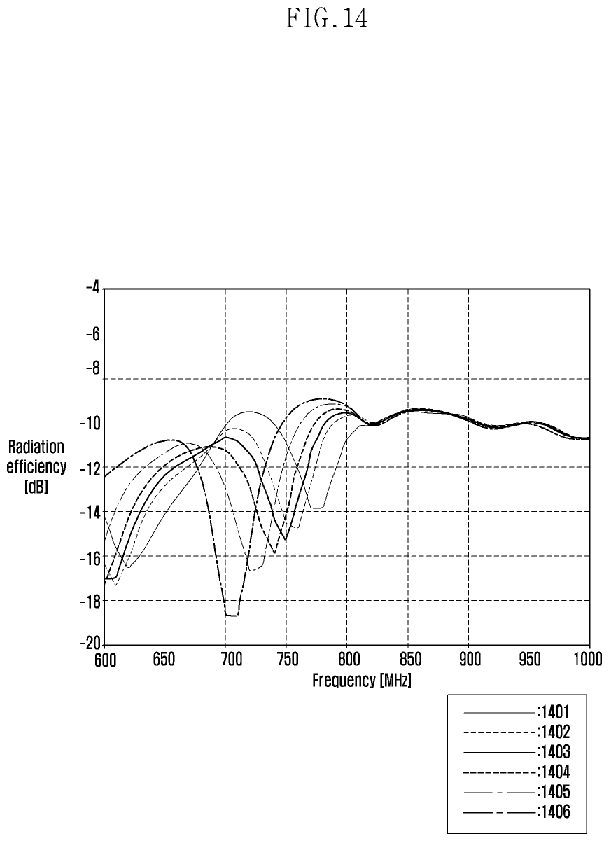

FIG. 14 is a graph illustrating antenna radiation performance for a first antenna including at least one first antenna radiator in a multi-foldable electronic device 2 (see FIG. 8A) in a folded state according to an element value of a first matching circuit M1 (see FIG. 8A) according to various embodiments.

With reference to FIG. 14, when an electromagnetic signal (or a radio signal, an RF signal, or a radiation current) is provided (or fed) to at least one first antenna radiator (e.g., the first partial metal portion 211 of FIG. 7), antenna radiation performance of the first antenna for a designated or selected frequency band (operating frequency band or usage frequency band) may be affected by frequency characteristics (e.g., resonant frequency) of parasitic resonance that varies according to an element value of the first matching circuit M1.

According to various embodiments, 1401 represents radiation efficiency for the first antenna in the case that the first matching circuit M1 is configured to provide (or form) a first element value. 1402 represents radiation efficiency for the first antenna in the case that the first matching circuit M1 is configured to provide (or form) a second element value. 1403 represents radiation efficiency for the first antenna in the case that the first matching circuit M1 is configured to provide (or form) a third element value. 1404 represents radiation efficiency for the first antenna in the case that the first matching circuit M1 is configured to provide (or form) a fourth element value. 1405 represents radiation efficiency for the first antenna in the case that the first matching circuit M1 is configured to provide (or form) a fifth element value. 1406 represents radiation efficiency for the first antenna in the case that the first matching circuit M1 is configured to provide (or form) a sixth element value. For example, the first element value may be about 0.6 nH (nanohenry). For example, the second element value may be about 1 nH. For example, the third element value may be about 1.2 nH. For example, the fourth element value may be about 1.5 nH. For example, the fifth element value may be about 2.2 nH. For example, the sixth element value may be about 4.7 nH. According to the element value of the first matching circuit M1, frequency characteristics (e.g., resonant frequency) of parasitic resonance with respect to radiation efficiency of the first antenna may vary. For example, FIG. 14 illustrates that as an inductance value of the first matching circuit M1 increases, the frequency of parasitic resonance shifts lower.

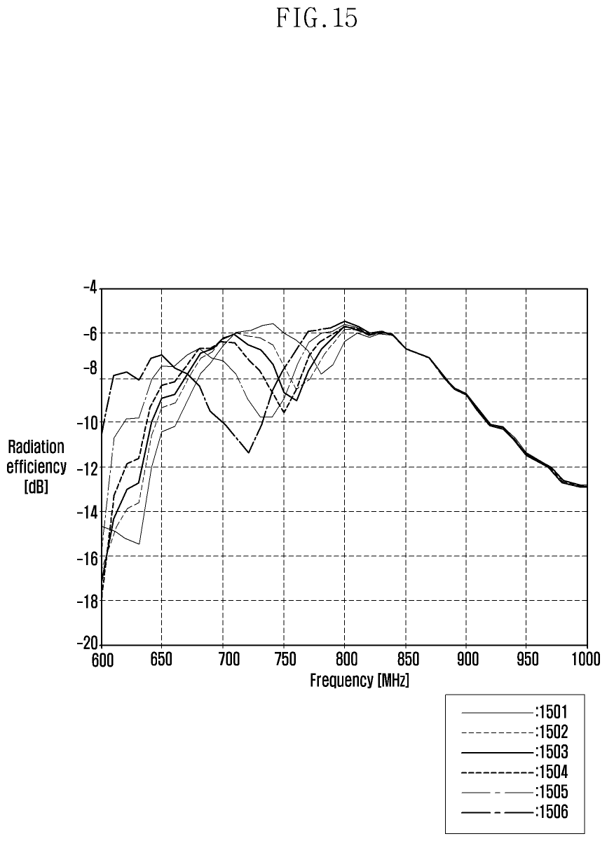

FIG. 15 is a graph illustrating antenna radiation performance for a second antenna including at least one second antenna radiator in a multi-foldable electronic device 2 (see FIG. 8A) in a folded state according to an element value of a second matching circuit M2 (see FIG. 8A) according to various embodiments.

With reference to FIG. 15, when an electromagnetic signal (or a radio signal, an RF signal, or a radiating current) is provided (or fed) to at least one second antenna radiator (e.g., the second partial metal portion 212 of FIG. 7), antenna radiation performance of the second antenna for a designated or selected frequency band (operating frequency band or usage frequency band) may be affected by frequency characteristics (e.g., resonant frequency) of parasitic resonance that varies according to the element value of the second matching circuit M2.

According to various embodiments, 1501 represents radiation efficiency for the second antenna in the case that the second matching circuit M2 is configured to provide (or form) a first element value. 1502 represents radiation efficiency for the second antenna in the case that the second matching circuit M2 is configured to provide (or form) a second element value. 1503 represents radiation efficiency for the second antenna in the case that the second matching circuit M2 is configured to provide (or form) a third element value. 1504 represents radiation efficiency for the second antenna in the case that the second matching circuit M2 is configured to provide (or form) a fourth element value. 1505 represents radiation efficiency for the second antenna in the case that the second matching circuit M2 is configured to provide (or form) a fifth element value. 1506 represents radiation efficiency for the second antenna in the case that the second matching circuit M2 is configured to provide (or form) a sixth element value. For example, the first element value may be about 0.6 nH. For example, the second element value may be about 1 nH. For example, the third element value may be about 1.2 nH. For example, the fourth element value may be about 1.5 nH. For example, the fifth element value may be about 2.2 nH. For example, the sixth element value may be about 4.7 nH. According to the element values of the second matching circuit M1, frequency characteristics (e.g., resonance frequency) of parasitic resonance with respect to radiation efficiency of the second antenna may vary. For example, FIG. 15 illustrates that as an inductance value of the second matching circuit M2 increases, the frequency of parasitic resonance shifts lower.

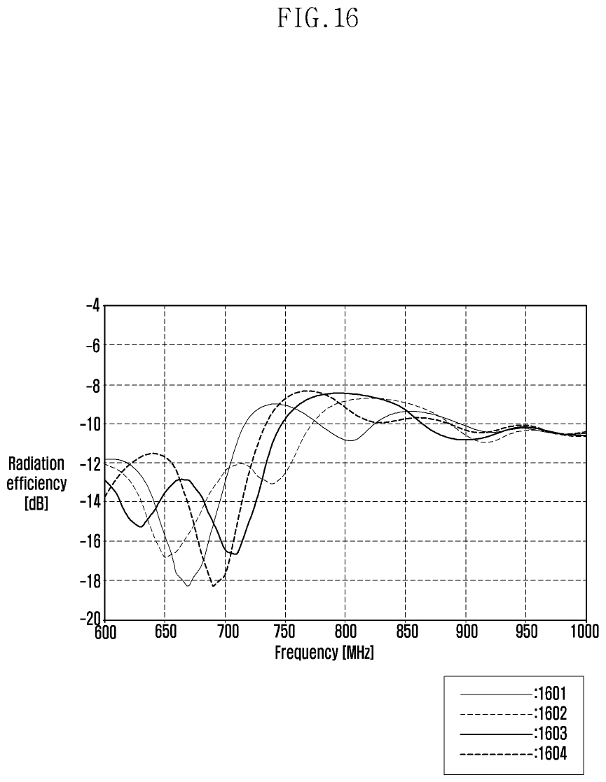

FIG. 16 is a graph illustrating antenna radiation performance for a first antenna including at least one first antenna radiator in a multi-foldable electronic device 2 (see FIG. 8A) in a folded state according to various embodiments.

With reference to FIGS. 16, 1601, 1602, 1603, and 1604 respectively represent radiation efficiency of the first antenna when the phase of an electromagnetic signal (or a wireless signal, an RF signal, or a radiating current) provided (or fed) to at least one first antenna radiator (e.g., the first partial metal portion 211 of FIG. 7) is varied. For example, the resonant frequency of the first antenna may be determined at least in part by the phase of the electromagnetic signal, and the phase may vary according to an element value provided (or formed) by the matching circuit for the first antenna. 1601 represents radiation efficiency of the first antenna, for example, in the case that the matching circuit is configured to provide (or form) an element value of about 1.0 nH. 1602 represents radiation efficiency of the first antenna, for example, in the case that the matching circuit is configured to provide (or form) an element value of about 2.2 nH. 1603 represents radiation efficiency of the first antenna, for example, in the case that the matching circuit is configured to provide (or form) an element value of about 3.3 nH. 1604 represents radiation efficiency of the first antenna, for example, in the case that the matching circuit is configured to provide (or form) an element value of about 4.7 nH. Antenna radiation performance of the first antenna for a designated or selected frequency band (operating frequency band or usage frequency band) may be affected by frequency characteristics (e.g., resonant frequency) of parasitic resonance that varies according to the phase of a radiating current of an electromagnetic signal provided to at least one first antenna radiator.

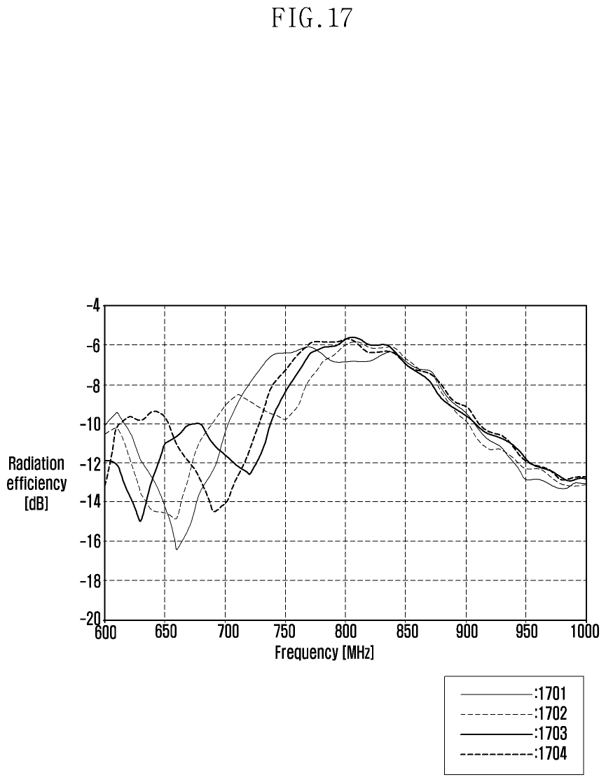

FIG. 17 is a graph illustrating antenna radiation performance for a second antenna including at least one second antenna radiator in a multi-foldable electronic device 2 (see FIG. 8A) in a folded state according to various embodiments.

With reference to FIGS. 17, 1701, 1702, 1703, and 1704 respectively represent radiation efficiency of the second antenna when the phase of an electromagnetic signal (or a wireless signal, an RF signal, or a radiating current) provided (or fed) to at least one second antenna radiator (e.g., the second partial metal portion 212 of FIG. 7) is varied. For example, a resonant frequency of the second antenna may be determined at least in part by the phase of the electromagnetic signal, and the phase may vary according to an element value provided (or formed) by the matching circuit for the second antenna. 1701 represents radiation efficiency of the second antenna, for example, in the case that the matching circuit is configured to provide (or form) an element value of about 1.0 nH. 1702 represents radiation efficiency of the second antenna, for example, in the case that the matching circuit is configured to provide (or form) an element value of about 2.2 nH. 1703 represents radiation efficiency of the second antenna, for example, in the case that the matching circuit is configured to provide (or form) an element value of about 3.3 nH. 1704 represents radiation efficiency of the second antenna, for example, in the case that the matching circuit is configured to provide (or form) an element value of about 4.7 nH. Antenna radiation performance of the second antenna for a designated or selected frequency band (operating frequency band or usage frequency band) may be affected by frequency characteristics (e.g., resonant frequency) of parasitic resonance that varies according to the phase of a radiating current of an electromagnetic signal provided to at least one second antenna radiator.

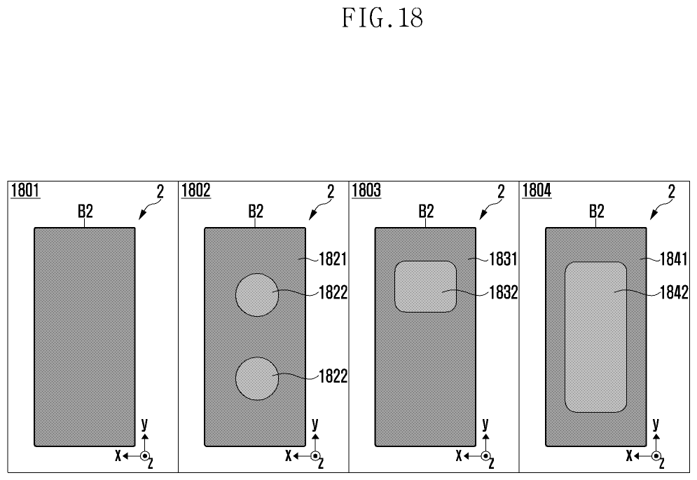

FIG. 18 is a diagram illustrating a portion of a multi-foldable electronic device 2 in an unfolded state according to various embodiments.

It should be understood that various combinations of features and/or embodiments disclosed in connection with FIG. 18 are contemplated and encompassed by the disclosure. Various combinations of features described below in connection with FIG. 18 may be considered to be included in the disclosure as specific examples.

With reference to FIG. 18, at least a portion of the second back cover B2 may be made of a metal material in place of the metal layer 6 (see FIG. 6). With reference to 1801, the entire area of the second back cover B2 may be made of a metal material in place of the metal layer 6 (see FIG. 6). With reference to 1802, 1803, or 1804, a partial area of the second back cover B2 may be implemented as a metal area 1821, 1831, or 1841 in place of the metal layer 6 (see FIG. 6), and another partial area of the second back cover B2 may be implemented as a non-metal area 1822, 1832, or 1842. The non-metallic area 1822, 1832, or 1842 may be formed, for example, by injection molding. The non-metallic area 1822, 1832, or 1842 of the second back cover B2 may be disposed, for example, in an opening formed in the metal area 1821, 1831, or 1841, when viewed from above the second back cover B2. Examples of 1801, 1802, 1803, and 1804 illustrate that a shape of the metal area included in the second back cover B2 may be implemented in various ways. When an electromagnetic signal (or a radio signal, an RF signal, or a radiating current) is provided (or fed) to at least one antenna radiator (e.g., the first partial metal portion 211 and/or the second partial metal portion 212 of FIG. 7), antenna radiation performance for a designated or selected frequency band (operating frequency band or usage frequency band) may be affected by frequency characteristics (e.g., resonant frequency) of parasitic resonance that varies according to the shape of the metal area included in the second back cover B2.

According to various embodiments, the non-metallic area 1822, 1832, or 1842 of the second back cover B2 may not be limited to shapes such as a circle or a square, or may additionally be implemented in a shape including a non-metallic area such as a character.

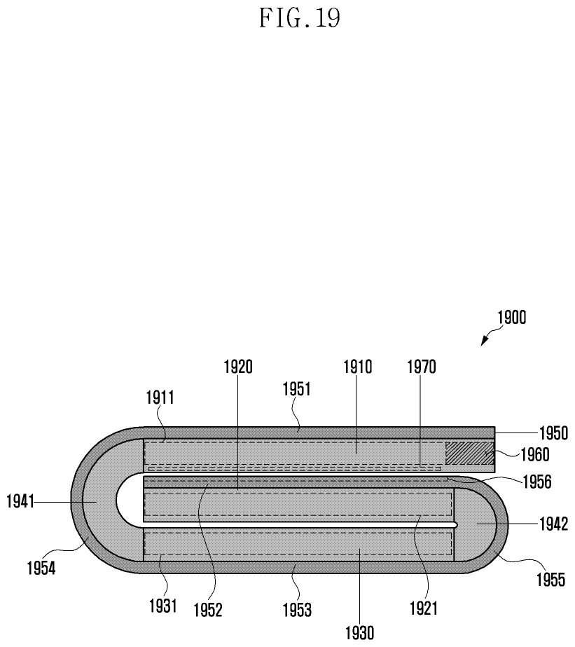

FIG. 19 is a diagram illustrating a folded state of a multi-foldable electronic device 1900 according to various embodiments.

It should be understood that various combinations of features and/or embodiments disclosed in connection with FIG. 19 are contemplated and encompassed by the disclosure. Various combinations of features described below in connection with FIG. 19 may be considered to be included in the disclosure as specific examples.

With reference to FIG. 19, a multi-foldable electronic device 1900 may include a first housing 1910 (e.g., the first housing 21 of FIG. 6), a second housing 1920 (e.g., the second housing 22 of FIG. 6), and a third housing 1930 (e.g., the third housing 23 of FIG. 6). The first housing 1910 and the third housing 1930 may be rotatably connected via a first hinge part 1941 (e.g., the first hinge part H1 of FIG. 2C). The second housing 1920 and the third housing 1930 may be rotatably connected via a second hinge part 1942 (e.g., the first hinge part H1 of FIG. 2C). In a folded state of the multi-foldable electronic device 1900, the second housing 1920 may be positioned between the first housing 1910 and the third housing 1930.

According to various embodiments, the multi-foldable electronic device 1900 may include a flexible display module 1950 (e.g., the first display module 810 of FIG. 8A). The flexible display module 1950 may include a first display area 1951 (e.g., the first display area 31 of FIG. 8A) disposed in or coupled to the first housing 1910, a second display area 1952 (e.g., the second display area 32 of FIG. 8A) disposed in or coupled to the second housing 1920, and a third display area 1953 (e.g., the third display area 33 of FIG. 8A) disposed in or coupled to the third housing 1930. In the folded state of the multi-foldable electronic device 1900, the first housing 1910 may be positioned between the first display area 1951 and the second display area 1952. In the folded state of the multi-foldable electronic device 1900, the second display area 1952 may be positioned between the first housing 1910 and the second housing 1920. In the folded state of the multi-foldable electronic device 1900, the second housing 1920 and the third housing 1930 may be positioned between the second display area 1952 and the third display area 1953. The flexible display module 1950 may include a first bendable display area 1954 (e.g., the first bendable display area 34 of FIG. 8A) between the first display area 1951 and the third display area 1953. The first hinge part 1941 may be configured to support the first bendable display area 1954. The flexible display module 1950 may include a second bendable display area 1955 (e.g., the second bendable display area 35 of FIG. 8A) between the second display area 1952 and the third display area 1953. The second hinge part 1942 may be configured to support the second bendable display area 1955.

According to various embodiments, the multi-foldable electronic device 1900 may include a first ground structure 1911 positioned in the first housing 1910, a second ground structure 1921 (e.g., the second ground structure of FIG. 8A) positioned in the second housing 1920, and a third ground structure 1931 positioned in the third housing 1930. The first ground structure 1911 and the third ground structure 1931 may be electrically connected via the first hinge part 1941 and/or an electrical connection member (e.g., FPCB) disposed across the first hinge part 1941. The second ground structure 1921 and the third ground structure 1931 may be electrically connected via the second hinge part 1942 and/or an electrical connecting member (e.g., FPCB) disposed across the second hinge part 1942.

According to various embodiments, the multi-foldable electronic device 1900 may include an antenna radiator 1960 (e.g., the first partial metal portion 211 and/or the second partial metal portion 212 of FIG. 7) in which a wireless communication circuit (e.g., the wireless communication module 192 of FIG. 1) included in the multi-foldable electronic device 1900 is configured to transmit and/or receive an electromagnetic signal (or a radio signal, an RF signal, or a radiating current). For example, the antenna radiator 1960 may be implemented as a part of the first ground structure 1911 positioned in the first housing 1910. The antenna radiator 1960 may be, for example, a part of the first ground structure 1911 positioned close to or substantially forming an outermost portion of the first housing 1910 in a direction from the first hinge part 1941 to the second hinge part 1942 in an unfolded state (not separately illustrated) of the multi-foldable electronic device 1900. The antenna radiator 1960 may include, for example, a part of a side member (also referred to as a lateral member, a side structure, or a side bezel structure) of the first housing 1910. In various embodiments, when viewed from above the first display area 1951, the antenna radiator 1960 may at least partially overlap the second hinge part 1942 in the folded state of the multi-foldable electronic device 1900. In various embodiments, the antenna radiator 1960 may be positioned under the rear surface of the first display area 1951. When viewed from above the first display area 1951, the first display area 1951 may overlap with the antenna radiator 1960. The position or number of the antenna radiators 1960 is not limited to the illustrated example.

According to various embodiments, in a folded state of a multi-foldable electronic device 1900, the first ground structure 1911 and the conductive portion 1956 included in the second display area 1952 of the flexible display module 1950 may form a waveguide structure. The flexible display module 1950 may include, for example, a ground plane (e.g., electromagnetic shielding layer) of a metal material that forms at least a portion of a rear surface thereof or at least partially disposed on a rear surface thereof, and the conductive portion 1956 included in the second display area 1952 may be a partial ground plane included in the second display area 1952 among the ground planes. In the folded state of the multi-foldable electronic device 1900, when the wireless communication circuit provides (or feeds) an electromagnetic signal to the antenna radiator 1960, a waveguide structure including the conductive portion 1956 the first ground structure 1911 and included in the second display area 1952 may form parasitic resonance due to electromagnetic wave energy radiated from the antenna radiator 1960. The multi-foldable electronic device 1900 according to various embodiments of the disclosure may include a metal layer 1970 positioned in the first housing 1910. The metal layer 1970 may be at least partially positioned between the first ground structure 1911 and the second display area 1952 in the folded state of the multi-foldable electronic device 1900. The metal layer 1970 may be electrically connected to the first ground structure 1911. The metal layer 1970 may enhance the ground connection between the first ground structure 1911 and the conductive portion 1956 included in the second display area 1952 in the folded state of the multi-foldable electronic device 1900. The metal layer 1970 may reduce parasitic resonance or adjust a frequency of parasitic resonance so that the waveguide structure including the first ground structure 1911 and the conductive portion 1956 included in the second display area 1952 does not generate parasitic resonance in the operating frequency band for the antenna radiator 1960. The metal layer 1970 may enable the conductive portion 1956, included in the second display area 1952, to be electromagnetically well integrated with the first ground structure 1911 as an antenna ground for the antenna radiator 1960 so that the frequency of parasitic resonance formed by the waveguide structure does not fall within the operating frequency band of the antenna including the antenna radiator 1960.

According to various embodiments, the first housing 1910 may include a back cover (not separately illustrated) facing in a direction opposite to the first display area 1951. The metal layer 1960 may be positioned between the back cover and the first ground structure 1911. The metal layer 1960 may be disposed on (e.g., attached to) the back cover. In various embodiments, the back cover may be made of a metal material in place of the metal layer 1960 and be electrically connected to the first ground structure 1911.

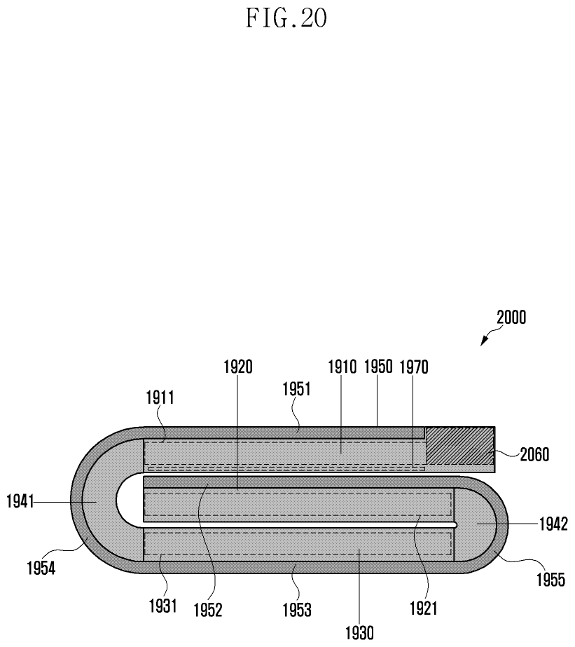

FIG. 20 is a diagram illustrating a folded state of a multi-foldable electronic device 2000 according to various embodiments.

It should be understood that various combinations of features and/or embodiments disclosed in connection with FIG. 20 are contemplated and encompassed by the disclosure. Various combinations of features described below in connection with FIG. 20 may be considered to be included in the disclosure as specific examples.

With reference to FIG. 20, a multi-foldable electronic device 2000 may include a first housing 1910, a second housing 1920, and a third housing 1930. The multi-foldable electronic device 2000 may include a first ground structure 1911 positioned in the first housing 1910, a second ground structure 1921 positioned in the second housing 1920, and a third ground structure 1931 positioned in the third housing 1930. The multi-foldable electronic device 2000 may include a first hinge part 1941 and a second hinge part 1942. The multi-foldable electronic device 2000 may include a flexible display module 1950. The flexible display module 1950 may include a first display area 1951, a second display area 1952, and a third display area 1953. The flexible display module 1950 may include a first bendable display area 1954. The flexible display module 1950 may include a second bendable display area 1954. The multi-foldable electronic device 2000 may include a metal layer 1970. Descriptions of some components that are the same as those in the previous embodiment may not be repeated.

According to various embodiments, the multi-foldable electronic device 2000 may include an antenna radiator 2060 (e.g., the first partial metal portion 211 and/or the second partial metal portion 212 of FIG. 7). The antenna radiator 2060 may include a portion of the first ground structure 1911. The antenna radiator 2060 according to the example of FIG. 20 may not overlap with the first display area 1951, when viewed from above the first display area 1951, compared to the antenna radiator 1960 according to the example of FIG. 19. The antenna radiator 1960 may include, for example, a portion (e.g., a portion of a screen bezel) of the first ground structure 1911 configured to surround an edge of the first display area 1951.

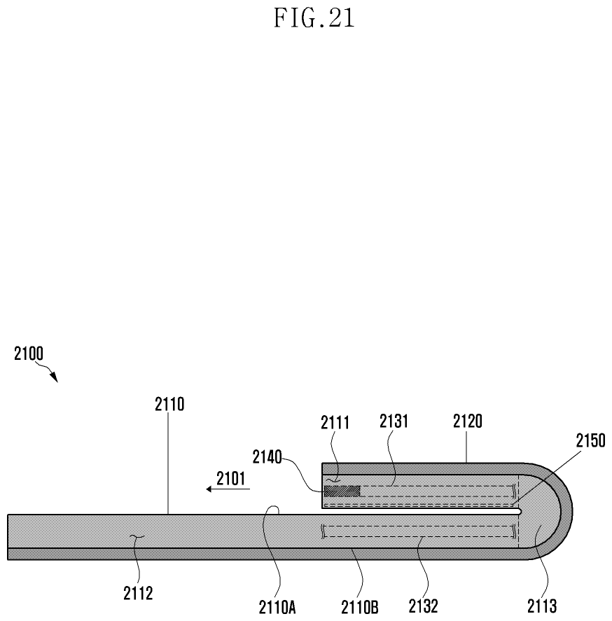

FIG. 21 is a diagram illustrating a slidable electronic device 2100 according to various embodiments.

It should be understood that various combinations of features and/or embodiments disclosed in connection with FIG. 21 are contemplated and encompassed by the disclosure. Various combinations of features described below in connection with FIG. 21 may be considered to be included in the disclosure as specific examples.

With reference to FIG. 21, a slidable electronic device 2100 may include a slidable housing 2110 and a flexible display module 2120 disposed in or coupled to the slidable housing 2110. The slidable housing 2110 may be implemented such that a first portion 2111 thereof is slidable in a first direction 2101 relative to a second portion 2112 thereof. The first portion 2111 and the second portion 2112 may overlap in a direction perpendicular to the first direction 2101. When the first portion 2111 slides in the first direction 2101 relative to the second portion 2112, the first portion 2111 may expand, and the second portion 2112 may contract due to the expansion of the first portion 2111. FIG. 21 illustrates a state in which the first portion 2111 is not slid in the first direction 2101 relative to the second portion 2112. The slidable housing 2110 may include a bendable portion 2113 between the first portion 2111 and the second portion 2112 that overlap each other. When the first portion 2111 is slid in the first direction 2101 relative to the second portion 2112, a position of the bendable portion 2113 in the slidable housing 2110 may vary. The slidable housing 2110 may include a first surface 2110A and a second surface 2110B positioned on the side opposite to the first surface 2110A. The slidable housing 2110 may be implemented such that the first surface 2110A folds inward at the bendable portion 2113. The flexible display module 2120 may be disposed in or coupled to the second side 2110B of the slidable housing 2110 and slide together with the slidable housing 2110.

According to various embodiments, the slidable electronic device 2100 may include a ground structure positioned in the slidable housing 2110. The ground structure may extend from the first portion 2111 to the second portion 2112 across the bendable portion 2113. A first partial ground structure 2131 positioned in the first portion 2111 of the ground structure and a second partial ground structure 2132 positioned in the second portion 2112 of the ground structure may be spaced apart from each other in a direction perpendicular to the first direction 2101 and overlap each other. When the first portion 2111 slides in the first direction 2101 relative to the second portion 2112, the first partial ground structure 2131 may expand due to expansion of the first portion 2111, and the second partial ground structure 2132 may contract due to contraction of the second portion 2112.

According to various embodiments, the slidable electronic device 2100 may include an antenna radiator 2140 configured such that a wireless communication circuit (e.g., the wireless communication module 192 of FIG. 1) included therein transmits and/or receives an electromagnetic signal (or a radio signal, an RF signal, or a radiating current). The antenna radiator 2140 may be implemented as a part of the first partial ground structure 2131. The antenna radiator 2140 may be, for example, a part of the first partial ground structure 2131 positioned close to or substantially forming the outermost portion of the slidable housing 2110 spaced apart from the bendable portion 2113 in the first direction 2101. The antenna radiator 2140 may include, for example, a part of a side member (also referred to as a lateral member, a side structure, or a side bezel structure) of the slidable housing 2110. In various embodiments, the position or number of the antenna radiator 2140 is not limited to the illustrated example.

According to various embodiments, a first partial ground structure 2131 positioned in a first portion 2111 of a slidable housing 2110 and a second partial ground structure 2132 positioned in the second portion 2112 of the slidable housing 2110 may form a waveguide structure. When a wireless communication circuit provides (or feeds) an electromagnetic signal to the antenna radiator 2140, the waveguide structure including the first partial ground structure 2131 and the second partial ground structure 2132 may form parasitic resonance due to electromagnetic wave energy radiated from the antenna radiator 2140. The slidable electronic device 2100 of the disclosure may include a metal layer 2150 positioned between the first partial ground structure 2131 and the second partial ground structure 2132. The metal layer 2150 may be positioned at least partially between the first partial ground structure 2131 and the second partial ground structure 2132, and be positioned in the first portion 2110 of the slidable housing 2110. The metal layer 2150 may be electrically connected to the first partial ground structure 2131. The metal layer 2150 may enhance a ground connection between the first partial ground structure 2131 and the second partial ground structure 2132. The metal layer 2150 may reduce parasitic resonance or adjust the frequency of parasitic resonance so that the waveguide structure including the first partial ground structure 2131 and the second partial ground structure 2132 does not generate parasitic resonance in the operating frequency band for the antenna radiator 2140. To prevent and/or suppress the frequency of parasitic resonance formed by the waveguide structure from falling within the operating frequency band of the antenna including the antenna radiator 2140, the metal layer 2150 may enable the first partial ground structure 2131 and the second partial ground structure 2132 to function effectively as an antenna ground for the antenna radiator 2140.

According to various example embodiments of the disclosure, a multi-foldable electronic device 2 includes a multi-foldable housing, a flexible display module (e.g., a first display module 3), at least one antenna radiator (e.g., the first partial metal portion 211 and/or the second partial metal portion 212), and a metal layer 6. The multi-foldable housing includes a first housing 21, a second housing 22, and a third housing 23 between the first housing 21 and the second housing 22. The multi-foldable housing includes a first hinge part H1 configured to rotatably connect the first housing 21 and the third housing 23. The multi-foldable housing includes a second hinge part H2 configured to rotatably connect the second housing 22 and the third housing 23. The multi-foldable housing is configured such that the second housing 22 is positioned between the first housing 21 and the third housing 23 in the folded state of the multi-foldable electronic device 2. The flexible display module includes a first display area 31 disposed in the first housing 21, a third display area 33 extended from the first display area 31 and disposed in the third housing 23, and a second display area 32 extended from the third display area 33 and disposed in the second housing 22. At least one antenna radiator is configured to transmit and/or receive a signal of a designated frequency band. The metal layer 6 is positioned in the second housing 22 and is configured to adjust frequency characteristics for at least one antenna radiator in the folded state of the multi-foldable electronic device 2. The metal layer 6 is positioned between the first display area 31 of the flexible display module 24 and a ground structure (e.g., the second ground structure 820) positioned in the second housing 22 in the folded state of the multi-foldable electronic device 2. The metal layer 6 is electrically connected to the ground structure.

According to various example embodiments of the disclosure, the metal layer 6 may be configured to adjust the frequency of parasitic resonance formed between a first display area 31 of a flexible display module (e.g., a first display module 3) and a ground structure (e.g., a second ground structure 820) positioned in the second housing 22 in the folded state of a multi-foldable electronic device 2.

According to various example embodiments of the disclosure, the metal layer 6 may be configured to adjust a capacitance value formed by a first display area 31 of a flexible display module (e.g., a first display module 3) and a ground structure (e.g., a second ground structure 820) positioned in the second housing 22 in the folded state of the multi-foldable electronic device 2.

According to various example embodiments of the disclosure, a flexible display module (e.g., a first display module 3) may include an electromagnetic shielding layer (e.g., a ground plane 810). In the folded state of the multi-foldable electronic device 2, the metal layer 6 may be configured to adjust a capacitance value formed by a part (e.g., a first partial ground plane 811) of the electromagnetic shielding layer included in the first display area 31 and a ground structure (e.g., a second ground structure 820) positioned in the second housing 22.

According to various example embodiments of the disclosure, the second housing 22 may include a back cover (e.g., the second back cover B2) positioned on the side opposite to the second display area 32 of the flexible display module (e.g., the first display module 3), and a bracket (e.g., the second bracket F21) configured to support the second display area 32 of the flexible display module. The metal layer 6 may be disposed on the back cover between the back cover and the bracket.

According to various example embodiments of the disclosure, the metal layer 6 may be a back cover (e.g., a second back cover B2) positioned in the second housing 22.

According to various example embodiments of the disclosure, in a folded state of the multi-foldable electronic device 2, a separation distance between a first display area 31 of the flexible display module (e.g., the first display module 3) and a ground structure (e.g., a second ground structure 820) positioned in the second housing 22 may be greater than that between a second display area 32 of the flexible display module and the third display area 33 of the flexible display module.

According to various example embodiments of the disclosure, the multi-foldable electronic device 2 may include a battery (e.g., a second battery 522) disposed in the bracket between the back cover (e.g., the second back cover B2) of the second housing 22 and the bracket (e.g., the second bracket F21) of the second housing 22. The metal layer 6 may not overlap with the battery in a direction orthogonal to the back cover of the second housing 22.

According to various example embodiments of the disclosure, the bracket (e.g., the second bracket F21) may include a hinge area 1103 configured to be connected to the second hinge part H2. In a direction orthogonal to the back cover (e.g., the second back cover B2) of the second housing 22, the metal layer 6 may include a portion (e.g., a third portion 63) overlapping the hinge area 1103 of the bracket.

According to various example embodiments of the disclosure, a ground structure (e.g., a second ground structure 820) may include a ground area of at least one PCB (e.g., at least one second PCB 512) positioned in the second housing 22, and a conductor included in the second housing 22 and electrically connected to the ground area of the at least one PCB. The metal layer 6 may be electrically connected to the ground area of the at least one PCB via at least one electrical connection member (e.g., a first electrical connection member 71 and/or a second electrical connection member 72) disposed between the metal layer 6 and the at least one PCB.

According to various example embodiments of the disclosure, at least one antenna radiator (e.g., the first partial metal portion 211 and/or the second partial metal portion 212) may be included in a side member (e.g., the first side member F12) that forms at least a portion of a side surface of the first housing 21.

According to various example embodiments of the disclosure, at least one antenna radiator (e.g., the first partial metal portion 211 and/or the second partial metal portion 212) may be positioned under the rear surface of the first display area 31 of the flexible display module (e.g., the first display module 3).

According to various example embodiments of the disclosure, the multi-foldable electronic device 2 may include at least one matching circuit (e.g., a first matching circuit M1 and/or a second matching circuit M2) disposed in at least one electrical path (e.g., a first grounding path GP1 and/or a second grounding path GP2) between the metal layer 6 and the ground structure (e.g., a second ground structure 820).

According to various example embodiments of the disclosure, the metal layer 6 may include a plurality of partial metal layers separated from each other.

According to various example embodiments of the disclosure, the multi-foldable electronic device 2 may include at least one switch (e.g., a first switch 1281, a second switch 1282, a third switch 1283, a fourth switch 1284, a fifth switch 1285, a sixth switch 1286, or a seventh switch 1287) configured to electrically connect or disconnect a plurality of partial metal layers of the metal layer 6 in response to a control signal.

The various example embodiments illustrated and described in the disclosure and the drawings are provided merely as examples to more easily describe the technical content and to help the understanding of the disclosure, and are not intended to limit the scope of the disclosure. Accordingly, it should be understood that the scope of various example embodiments of the disclosure includes various modifications or variations in addition to the various example embodiments disclosed herein. It should be understood that any embodiment(s) described herein may be combined with any other embodiment(s) described herein. For example, although the disclosure is described in the form of multiple embodiments, each defining a variety of features, it should be emphasized that some of these embodiments may appear to be related only through the same drawing or reference to the drawings. It should be understood that the disclosure includes various combinations of the embodiments described herein, as long as there is no clear contradiction between two (or more) embodiments. For example, in the case that features are presented as optional in the disclosure, various combinations of such optional features are considered to be within the scope of the disclosure.

What is claimed is:

1. A multi-foldable electronic device, comprising:
a multi-foldable housing comprises:
a first housing,
a second housing,
a third housing disposed between the first housing and the second housing,
a first hinge configured to rotatably connect the first housing and the third housing, and
a second hinge configured to rotatably connect the second housing and the third housing,
wherein in a folded state of the multi-foldable electronic device, the multi-foldable housing is configured such that the second housing is positioned between the first housing and the third housing;
a flexible display module comprising a display including a first display area) disposed in the first housing, a third display area extending from the first housing and disposed in the third housing, and a second display area extending from the third display area and disposed in the second housing;
at least one antenna radiator configured to transmit and/or receive signals of a designated frequency band; and
a metal layer positioned in the second housing and configured to adjust frequency characteristics of the at least one antenna radiator in the folded state of the multi-foldable electronic device,
wherein in the folded state of the multi-foldable electronic device, the metal layer is positioned between the first display area of the flexible display module and a ground structure comprising a conductive material positioned in the second housing, and is electrically connected to the ground structure.

2. The multi-foldable electronic device of claim 1, wherein the metal layer is configured to adjust a frequency of parasitic resonance formed between the first display area of the flexible display module and the ground structure positioned in the second housing in the folded state of the multi-foldable electronic device.

3. The multi-foldable electronic device of claim 1, wherein the metal layer is configured to adjust a capacitance value formed by the first display area of the flexible display module and the ground structure positioned in the second housing in the folded state of the multi-foldable electronic device.

4. The multi-foldable electronic device of claim 1, wherein the flexible display module comprises an electromagnetic shielding layer, and
wherein the metal layer is configured to adjust a capacitance formed by a portion of the electromagnetic shielding layer included in the first display area and the ground structure positioned in the second housing in the folded state of the multi-foldable electronic device.

5. The multi-foldable electronic device of claim 1, wherein the second housing comprises a back cover positioned on the side opposite to the second display area of the flexible display module, and a bracket configured to support the second display area of the flexible display module, and
wherein the metal layer is disposed between the back cover and the bracket on the back cover.

6. The multi-foldable electronic device of claim 1, wherein the metal layer includes a back cover positioned on the second housing.

7. The multi-foldable electronic device of claim 1, wherein in the folded state of the multi-foldable electronic device, a separation distance between the first display area of the flexible display module and the ground structure positioned in the second housing is greater than a separation distance between the second display area of the flexible display module and the third display area of the flexible display module.

8. The multi-foldable electronic device of claim 7, further comprising a battery disposed in the bracket between the back cover of the second housing and the bracket of the second housing,
wherein the metal layer is configured to not overlap with the battery in a direction perpendicular to the back cover of the second housing.

9. The multi-foldable electronic device of claim 8, wherein the bracket comprises a hinge area configured to be connected to the second hinge, and
wherein the metal layer comprises a portion overlapping the hinge area of the bracket in a direction perpendicular to the back cover of the second housing.

10. The multi-foldable electronic device of claim 1, wherein the ground structure comprises a ground area of at least one printed circuit board (PCB) positioned in the second housing, and a conductor included in the second housing and electrically connected to the ground area of the at least one PCB and
wherein the metal layer is electrically connected to the ground area of the at least one PCB through at least one electrical connecting member comprising a conductive material disposed between the metal layer and the at least one PCB.

11. The multi-foldable electronic device of claim 1, wherein the at least one antenna radiator is included in a side member including at least a portion of a side surface of the first housing.

12. The multi-foldable electronic device of claim 11, wherein the at least one antenna radiator is positioned under a rear surface of the first display area of the flexible display module.

13. The multi-foldable electronic device of claim 1, further comprising at least one matching circuit disposed in at least one electrical path between the metal layer and the ground structure.

14. The multi-foldable electronic device of claim 1, wherein the metal layer comprises a plurality of partial metal layers separated from each other.

15. The multi-foldable electronic device of claim 13, further comprising at least one switch configured to electrically connect and/or disconnect one or more of the plurality of partial metal layers of the metal layer in response to a control signal.
